(19) United States
(12) Patent Application Publication
(10) Pub. No.: US 2014/0051661 A1
(43) Pub. Date: Feb. 20, 2014

(54) NOVEL LIPOGENIC INHIBITORS AND USES THEREOF

(71) Applicants: Bhaskar C. Das, West Nyack, NY (US); Fajun Yang, Ardsley, NY (US); Xiaoping Zhao, Bronx, NY (US); Jeffrey E. Pessin, New York, NY (US); Haihong Zong, East Setauket, NY (US); Jun-Yuan Ji, College Station, TX (US)

(72) Inventors: Bhaskar C. Das, West Nyack, NY (US); Fajun Yang, Ardsley, NY (US); Xiaoping Zhao, Bronx, NY (US); Jeffrey E. Pessin, New York, NY (US); Haihong Zong, East Setauket, NY (US); Jun-Yuan Ji, College Station, TX (US)

(73) Assignees: The Texas A&M University System, College Station, TX (US); Albert Einstein College of Medicine of Yeshiva University, Bronx, NY (US)

(21) Appl. No.: 13/977,038

(22) PCT Filed: Feb. 15, 2012
(86) PCT No.: PCT/US12/25218

§ 371 Date: Oct. 24, 2013

Related U.S. Application Data
(60) Provisional application No. 61/443,426, filed on Feb. 16, 2011.

(51) Int. Cl. C07F 5/04

(52) U.S. Cl. CPC C07F 5/04
USPC 514/64; 558/288; 549/4

(57) ABSTRACT

The present invention provides resveratrol-based boron-containing analog! methods of use thereof in treatment of dyslipidemias and cancer.

### CROSS-REFERENCE TO RELATED APPLICATIONS

This application claims benefit of U.S. Provisional Application No. 61/443,426, filed Feb. 16, 2011, the contents of which are hereby incorporated by reference.

### FIELD OF THE INVENTION

The present invention relates generally to novel inhibitors of lipogenesis and their use in treating dyslipidemias and other diseases or disorders in a subject.

### BACKGROUND OF THE INVENTION

Throughout this application various publications are referred to in parenthesis. Full citations for these references may be found at the end of the specification. The disclosures of these publications are hereby incorporated by reference in their entirety into the subject application to more fully describe the art to which the subject invention pertains.

Age is a major risk factor for a number of human diseases, including cardiovascular disease, type 2 diabetes, cancer, and Alzheimer's disease. One primary metabolic change that occurs during aging is the dysregulation of lipid homeostasis, particularly increased fatty acid and cholesterol biosynthesis in non-adipose tissues, such as liver and skeletal muscle. Dysregulation of lipid homeostasis in humans is closely associated with major diseases, including obesity, cardiovascular disease, type 2 diabetes, cancer and Alzheimer's disease, which have constituted the leading cause of death and the primary health burden in developed countries (From CDC data). Environmental factors, such as diet and life style, can affect lipid metabolism by changing the activities of genes involved in this process. Western diets, unhealthy life styles and aging are known to cause dysregulation of lipid homeostasis, although the molecular mechanisms are still unknown. One common abnormality in modern humans is excessive activation of lipogenesis and cholesterogenesis. Changing diet and life style is often recommended for preventing these diseases. However, pharmacologic approaches that can correct the aberrant lipid metabolism by inhibiting lipid biosynthesis may have beneficial effects in preventing and treating major human diseases.

Among the known lipogenic regulators, the SREBP transcription factors are master regulators of lipid homeostasis (11, 12). Through activating the expression of rate-limiting lipogenic and cholesterogenic genes, such as fatty acid synthase (FAS) and HMG-CoA reductase (HMGCR), SREBPs promote the biosynthesis of fatty acid and cholesterol (11, 12). Therefore, suppressing the SREBP pathway may efficiently inhibit lipid biosynthesis. SREBP proteins are synthesized as inactive precursors that are tethered to the ER membrane when cellular levels of sterols or fatty acids (the end products of SREBP target genes) are high. Decrease of intracellular sterols or specific fatty acids results in the transportation of SREBPs to the Golgi where they undergo proteolytic maturation. The N-terminal fragment of SREBP transcription factors then migrates into the nucleus and activates transcription of target genes (11, 12).

Like many other transcription factors, the transcriptional activity of SREBP is precisely regulated by a number of transcriptional co-factors (13). Recent studies suggest that the putative anti-aging gene SIRT1, a NAD-dependent Class III histone deacetylase, can inhibit lipogenesis by repressing SREBP dependent gene expression (14-16). SIR2 (silent information regulator-2), the closest ortholog of mammalian SIRT1, was originally identified in yeast as a transcriptional silencer of telomeres, mating loci, and rDNA transcription (2, 3, 17, 18). SIR1 can deacetylate not only histone tails, but also a range of other proteins that represent key regulators in DNA damage, cell cycle, inflammation, and nutrient metabolism (2, 3, 17, 18).

There is a need for inhibitors of SREBP-target gene expression. The present invention discloses boron-containing compounds which show potent inhibitory effects on biosynthesis of both fatty acids and cholesterol by inhibiting SREBP-target gene expression in cultured cells and in vivo.

### SUMMARY OF THE INVENTION

A compound having the structure:

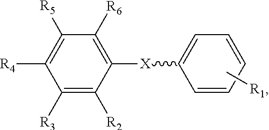

wherein R₁ is

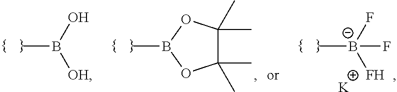

wherein the { } represents the point of attachment of R1 to the right hand aryl ring;
wherein X is either:

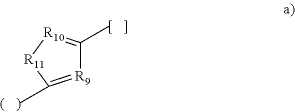

wherein (i) R₉ is C and R₁₀ is N and R₁₁ is O or (ii) R₉ and R₁₀ are N and R₁₁ is O;

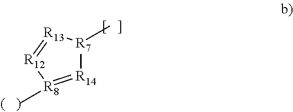

wherein R₈ is C, and wherein (i) R₇, R₁₂ and R₁₃ are N and R₁₄ is C or (ii): R₇, R₁₂, R₁₃ and R₁₄ are N;

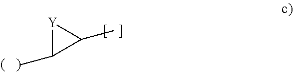

wherein Y is O, C, S or NH;

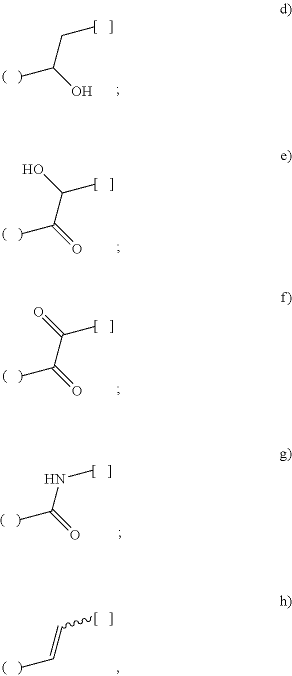

and wherein, in a) through h), ( ) represents the point of attachment to the left hand aryl ring and [ ] represents the point of attachment to the right hand aryl ring;
wherein R₂, R₃, R₄, R₅, and R₆ are, independently, —H, —OH, halogen, —OCH₃, —O—C₂H₂N(H(Boc), —O—C₂H₂—NH₂, —O—C₂H₂NHC(═O)CH₂OCH₂OCH₂OC₂H₄OC₂H₄NH₂, C1-C6 alkyl, aryl, phenyl, heteroaryl, arylalkyl, heterocyclic, C2-C6 alkenyl, C2-C6 alkynyl, —NO₂, —OC₂H₅, —O-alkyl, —SH, —S-alkyl, —NH₂, or —NH-alkyl;
or pharmaceutically acceptable salt thereof or a stereoisomer thereof.

A compound having the structure:

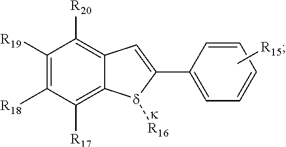

wherein R₁₅ is:

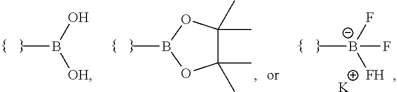

wherein the wavy line represents the point of attachment of R₁₅ to the aryl ring;
wherein atom δ is C, O, N, or S,
and when atom δ is O or S, bond κ and R₁₆ are absent; when atom δ is N, bond κ is present and R₁₆ is H, alkyl or aryl; when atom δ is C, bond κ is present and R₁₆ is H, alkyl or aryl;
where R₁₇, R₁₈, R₁₉ and R₂₀ are, independently, —H, —OH, halogen, —OCH₃, —O—C₂H₂—NH₂, C1-C6 alkyl, aryl, phenyl, heteroaryl, arylalkyl, heterocyclic, alkenyl, C2-C6 alkenyl, C2-C6 alkynyl, —NO₂, —OC₂H₅, —O-alkyl, —SH, —S-alkyl, —NH₂, or —NH-alkyl;
or pharmaceutically acceptable salt thereof or a stereoisomer thereof.

A composition, comprising any of the instant compounds, or pharmaceutically acceptable salt thereof or stereoisomer thereof, of any one of the instant compounds or pharmaceutically acceptable salts thereof.

A pharmaceutical composition comprising any of the instant compounds, or pharmaceutically acceptable salt thereof or stereoisomer thereof, and a pharmaceutically acceptable carrier.

A method of treating a dyslipidemia in a subject comprising administering to the subject any of the instant compounds, or pharmaceutically acceptable salt thereof or stereoisomer thereof, or the instant composition or pharmaceutical composition in an amount effective to treat the dyslipidemia in the subject.

A method of inhibiting fatty acid synthesis or cholesterol synthesis in a subject comprising administering to the subject any of the instant compounds, or pharmaceutically acceptable salt thereof or stereoisomer thereof, or the instant composition or pharmaceutical composition in an amount effective to inhibit fatty acid synthesis or cholesterol synthesis in the subject.

A method of inhibiting a lipogenic enzyme or cholesterolgenic enzyme in a subject comprising administering to the subject any of the instant compounds, or pharmaceutically acceptable salt thereof or stereoisomer thereof, or the instant composition or pharmaceutical composition in an amount effective to inhibit the lipogenic enzyme or the cholesterolgenic enzyme in the subject.

A method treating a cancer in a subject comprising administering to the subject any of the instant compounds, or pharmaceutically acceptable salt thereof or stereoisomer thereof, or the instant composition or pharmaceutical composition in an amount effective to treat the cancer in the subject.

### BRIEF DESCRIPTION OF THE DRAWINGS

FIG. 1: Resveratrol and boron-containing derivative of resveratrol.

FIG. 2: Retrosynthetic approach for pinacolylboro-nate-substituted stilbene derivative 1.

FIG. 3: Synthesis of bio-isosteres compounds of BF-102 by replacing the central double bond with different functional groups, a) amide, b) hydroxyethylene, c) alpha, beta-diketones, d) alpha hydroxyl ketones, e) oxazolidine, f) oxadiazole, g) triazole, h) tetrazole derivatives, and q, r, s, t) epoxide, cyclopropane, thaiirane and aziridines.

FIG. 4: Synthesis of bio-isosteres compounds of BF-102 by replacing the central double bond with different functional groups, i) amide, j) hydroxyethylene, k) alpha, beta-diketones, l) alpha hydroxyl ketones, m) oxazolidine, n) oxadiazole, o) triazole, and p) tetrazole, u, v, w, x) epoxide, cyclopropane, thaiirane and aziridines pinacolato ester to boronic acid and BF₃K salt.

FIG. 5: Synthesis of function-oriented library of BF-102 to study the SAR (Structure activity relationship): i) changing the hydroxyl group position in ring A, ii) 2-substituted benzofuran, iii) 2-substituted benzothiaphene, iv) 2-substituted indole, v) 1, 2 disubstituted indole, vi-x) pinacolato ester converted to boronic acid derivatives and xi-xv) pinacolatoester converted to potassium salt of borates.

FIG. 6: Procedure for generating affinity matrices of BF102.

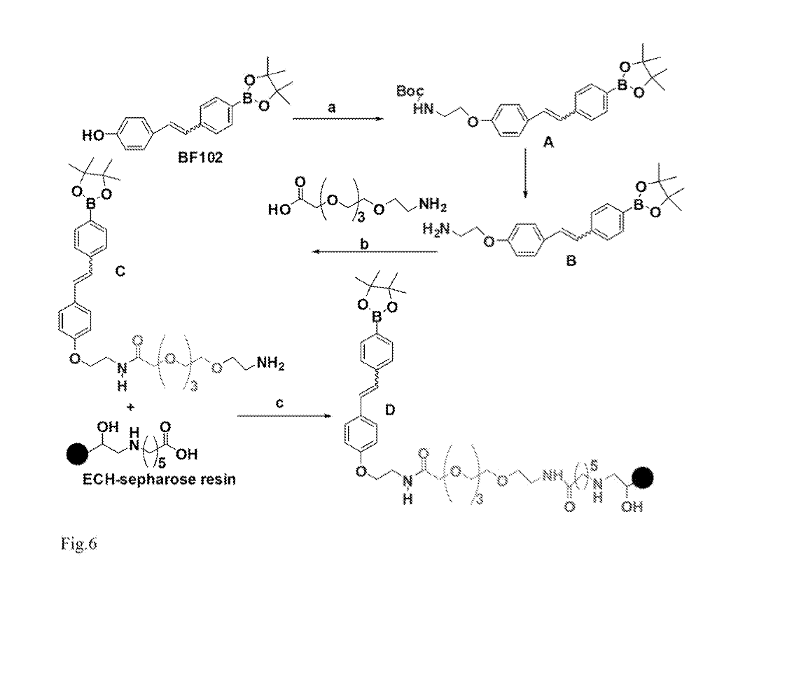

FIG. 7: Procedure for generating affinity matrices of BF62 inactive compound for control study.

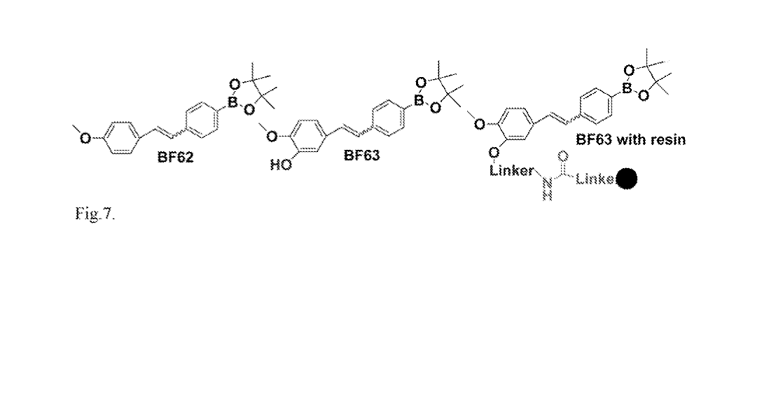

FIG. 8: Relative mRNA levels of fatty acid synthase (FAS) (detected by quantitative RT-PCR) in HepG2 cells after 6 hours treatment with 30 μM of the compounds. Cyclophilin B was invariant control.

FIG. 9: Relative mRNA levels of HMG-CoA reductase (HMG-CR) in HepG2 cells after 6 hours treatment with 3 μM of the compounds.

FIG. 10: Relative rat of palmitate synthesis (deuterium enrichment method) in FAO cells after 12 hours treatment with 20 μM of BF-102. Data is average of three independent sample. #p<0.001 vs DMSO (n=3).

FIG. 11: Relative rate of cholesterol synthesis in HepG2 cells after 12 hours treatment with 20 μM of the compounds.

FIG. 12: Chemical structure of molecule BF-102 and other compounds.

FIGS. 13A-13B: BF-102 inhibits cholesterol biosynthesis. 13A. Relative mRNA levels of HMG-CoA reductase HMGCR) (detected by quantitative RT-PCR) in HepG2 cells treated with the indicated concentrations of BF-102 for 6 hours. Cyclophilin B was the invariant control. 13B. The synthesis rate of cholesterol (detected by the deuterium enrichment method) in FAO cells after 12 hours of treatment with BF-102 (20 μM). 14C. Eight-week old C57BL/6J mice were fed with high-fat diet (60% fat) (HFD) for 4 weeks, then treated with BF-102 (0.3 mg/g body weight per week) and HFD for a week by subcutaneously implanted osmotic pumps, and mice were fasted overnight and re-fed, for 5 hours. Hepatic mRNA levels were detected by quantitative RT-PCR. Cyclophilin B was the invariant control. *p<0.01 and #p<0.001 vs DMSO (n=3).

FIGS. 14A-14B: Effects of BF175 on fatty acid synthase (FAS) gene expression. 14A. Relative mRNA levels of fatty acid synthesis (FAS) (detected by quantitative RT-PCR) in HepG2 cells treated for 18 hours with indicated concentration of BF175. Cyclophilin B was the invariant control. #p 0.05 and *p<0.01 vs DMSO (n=3). 14B. Treatment of primary rat hepatocytes with BF175 (100 μM) overnight in the presence of 1000 nM insulin decreased FAS protein levels by Western blots. β-tubulin served as the loading control.

FIGS. 15A-15B: BF175 inhibits lipogenic gene expression in mouse livers in vivo. Methods: Eight-week old C57BL/6J mice were fed with high-fat diet (60% fat) (HFD) for 4 weeks, then treated with BF175 (0.3 mg/g body weight per week) and HFD for a week by subcutaneously implanted osmotic pumps, and mice were fasted overnight and re-fed for 5 hours. 15A. Nuclear SREBP-1c in liver extracts was determined by Western blots. β-tubulin served as the loading control. 15B. Hepatic mRNA levels were detected by quantitative RT-PCR. Cyclophilin B was the invariant control. Data represents the Mean±SD (n=5), *p<0.01 and NS=not significant vs DMSO.

FIG. 16A-16E: Metabolic effects of BF175 infection in mice. Methods: Eight-week old C57BU6J mice were fed with high-fat diet (60% fat) (HFD) for 4 weeks, then treated with BF175 (0.3 mg/g body weight per week) and HFD for a week by subcutaneously implanted osmotic pumps, and mice were monitored in metabolic cages during the last 24 hours. 16A. Oxygen consumption. 16B. Carbon dioxide production. 16C. Energy expenditure. 16D. Respiratory exchange ratio (RER)=VCO₂/VO₂. 16E. Total physical activity. Data represents the Mean±SD (n=4, &p<0.5, *p<0.01, #p<0.001 and NS=not significant vs DMS.

FIG. 17A-17B: BF175 decreases plasma triglyceride levels and glucose tolerance in mice. 17A. Eight-week old C57BL/6J mice were fed with high-fat diet (60% fat) (HFD) for 4 weeks, then treated with BF175 (0.3 mg/g body weight per week) and HFD for a week by subcutaneously implanted osmotic pumps. Plasma triglyceride (TG) levels were measured. 17B. Eight-week old C57BL/6J mice were fed with high-fat diet (60% fat) (HFD) for 4 weeks, then treated with BF175 (0.2% in HFD), and glucose tolerance test was performed after 4 weeks of treatment. Data represents the Mean±SD (n=6), &p<0.05 and NS=not significant vs control.

FIGS. 18A-18E: Metabolic changes in mice fed with BF175. Methods: Eight-week old C57BL/6J mice were fed with high-fat diet 60% fat) (HFD) for 4 weeks, the treated with BF175 (0.2% in HFD), and mice were monitored in metabolic cages after 5 weeks of treatment. 18A. Oxygen consumption. 18B. Carbon dioxide production. 18C. Energy expenditure. 18D. Respiratory exchange ratio (RER)=VCO₂/NO₂. 18E. Total physical activity. Data represents the Mean±SD (n=4), &p<0.05, *p<0.01, #p<0.001 and NS=not significant vs control.

FIGS. 19A-19B: SIRT1-dependent effects of BF175. 19A. Wild-type (WT) or Sir2 knockout (Sir2KO) Drosophila larvae were treated with DMSO or 0.1 mM BF175 in food. Lipid levels were determined by measuring OD of isopropanol extracts at 510 nm after staining with Oil Red 0. Data represents the Mean±SD (n=15), #p<0.001 vs DMSO. 19B. Effects of BF175 on SIRT1 activity in vitro. Data represents the Mean±SD (n=3), *p<0.01 vs DMSO.

### DETAILED DESCRIPTION OF THE INVENTION

A compound having the structure:

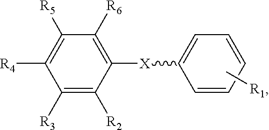

wherein R₁ is

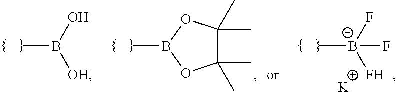

wherein the { }represents the point of attachment of R₁ to the right-hand aryl ring;
wherein X is either:

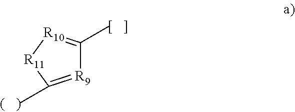

wherein (i) R₉ is C and R₁₀ is N and R₁₁ is O or (ii) R₉ and R₁₀ are N and R₁₁ is O;

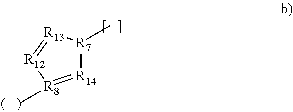

wherein R₈ is C, and wherein (i) R₇, R₁₂ and R₁₃ are N and R₁₄ is C or (ii) R₇, R₁₂, R₁₃ and R₁₄ are N;

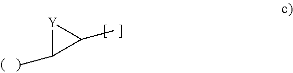

wherein Y is O, C, S or NH;

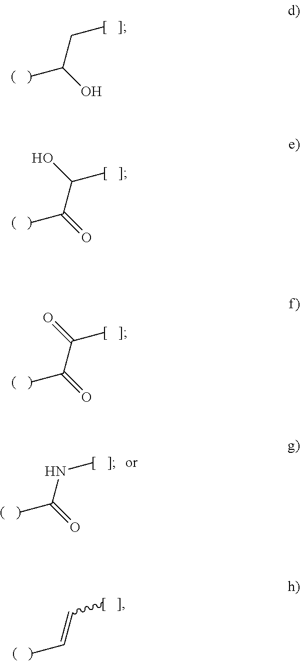

and wherein, in a) through h), ( ) represents the point of attachment to the left hand aryl ring and [ ] represents the point of attachment to the right hand aryl ring;
wherein R₂, R₃, R₄, R₅, and R₆ are, independently, —H, —OH, halogen, —OCH₃, —O—C₂H₂—N(H)Boc), —O—C₂H₂—NH₂, —O—C₂H₂NHC(═O)CH₂OCH₂OCH₂OC₂H₄OC₂H₄NH₂, C1-C6 alkyl, aryl, phenyl, heteroaryl, arylalkyl, heterocyclic, C2-C6 alkenyl, C2-C6 alkynyl, —NO₂, —OC₂H₅, —O-alkyl, —SH, —S-alkyl, —NH₂, or —NH-alkyl;
or pharmaceutically acceptable salt thereof or a stereoisomer thereof.

In an embodiment of the compound, or pharmaceutically acceptable salt thereof, or stereoisomer thereof, when R₄ is —OCH₃, then R₃ and R₅ are —OCH₃.

In an embodiment the compound, or pharmaceutically acceptable salt thereof, or stereoisomer thereof, has the structure:

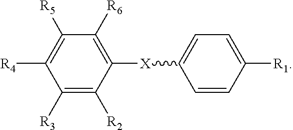

In an embodiment of the compound, or pharmaceutically acceptable salt thereof, or stereoisomer thereof, R₂, R₃, R₄, R₅, and R₆ are, independently, —H, —OH, halogen, —OCH₃, —O—C₂H₂N(H)(Boc), —O—C₂H₂—NH₂, or —O—C₂H₂NHC(═O)CH₂OCH₂OCH₂OC₂H₄OC₂H₄NH₂,

In an embodiment of the compound, or pharmaceutically acceptable salt thereof, or stereoisomer thereof, R₄ is OH and R₂, R₃, R₅ and R₆ are —H; or wherein R₂ is —OH and R₃, R₄, R₅ and R₆ are —H; or wherein R₃ and R₅ are halogen and R₄ is —H, and R₂ and R₆ are, independently, —H or —OH; or wherein R₃, R₄, R₅ are —OCH, and R₂ and R₆ are —H.

In an embodiment of the compound, or pharmaceutically acceptable salt thereof, or stereoisomer thereof, R₄ is —OH and R₂, R₃, R₅ and R₆ are —H.

In an embodiment of the compound, or pharmaceutically acceptable salt thereof, or stereoisomer thereof, R₃ and R₅ are —Cl and R₂, R₄, and R₆ are —H.

In an embodiment of the compound, or pharmaceutically acceptable salt thereof, or stereoisomer thereof, X is

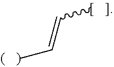

In an embodiment of the compound, or pharmaceutically acceptable salt thereof, or stereoisomer thereof, X is

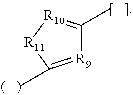

In an embodiment of the compound, or pharmaceutically acceptable salt thereof, or stereoisomer thereof, X is

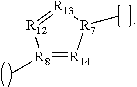

In an embodiment of the compound, or pharmaceutically acceptable salt thereof, or stereoisomer thereof X is

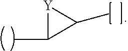

In an embodiment of the compound, or pharmaceutically acceptable salt thereof, or stereoisomer thereof, X is

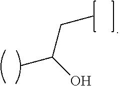

In an embodiment of the compound, or pharmaceutically acceptable salt thereof, or stereoisomer thereof, X is

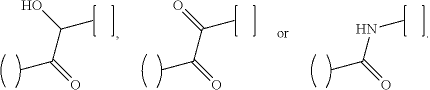

In an embodiment of the compound, or pharmaceutically acceptable salt thereof, or stereoisomer thereof, R1 is:

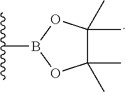 [SMILES: *B1OC(C)(C)C(C)(C)O1]

In an embodiment of the compound, or pharmaceutically acceptable salt thereof, or stereoisomer thereof, R1 is:

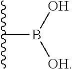 [SMILES: *B(O)O]

In an embodiment of the compound, or pharmaceutically acceptable salt thereof, or stereoisomer thereof, R1 is:

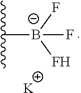 [SMILES: *[B-](F)(F)F ; [K+]]

In an embodiment the compound, or pharmaceutically acceptable salt thereof, or stereoisomer thereof, has the structure:

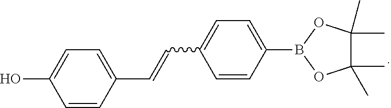 [SMILES: CC1(C)OB(c2ccc(C=Cc3ccc(O)cc3)cc2)OC1(C)C]

In an embodiment the compound, or pharmaceutically acceptable salt thereof, or stereoisomer thereof, has the structure;

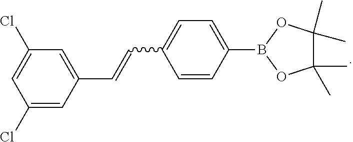 [SMILES: CC1(C)OB(c2ccc(C=Cc3cc(Cl)cc(Cl)c3)cc2)OC1(C)C]

In an embodiment the compound, or pharmaceutically acceptable salt thereof, or stereoisomer thereof has the structure:

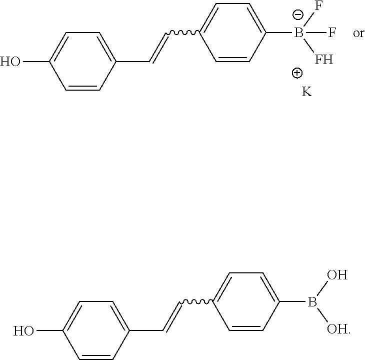 [SMILES: Oc1ccc(C=Cc2ccc([B-](F)(F)F)cc2)cc1 ; [K+] ; OB(O)c1ccc(C=Cc2ccc(O)cc2)cc1]

In an embodiment the compound, or pharmaceutically acceptable salt thereof, or stereoisomer thereof has the structure:

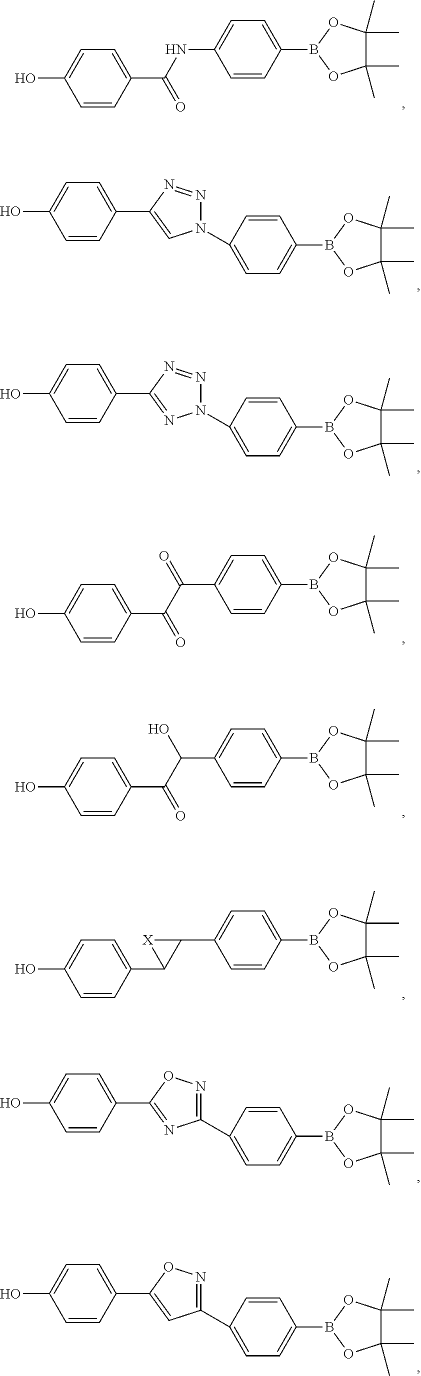

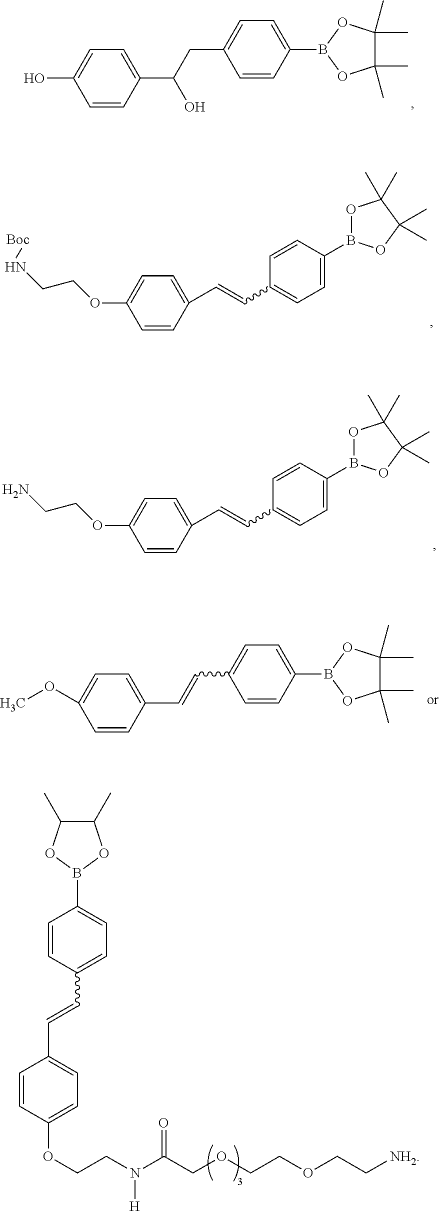

In an embodiment the compound, or pharmaceutically acceptable salt thereof, or stereoisomer thereof, has the structure:

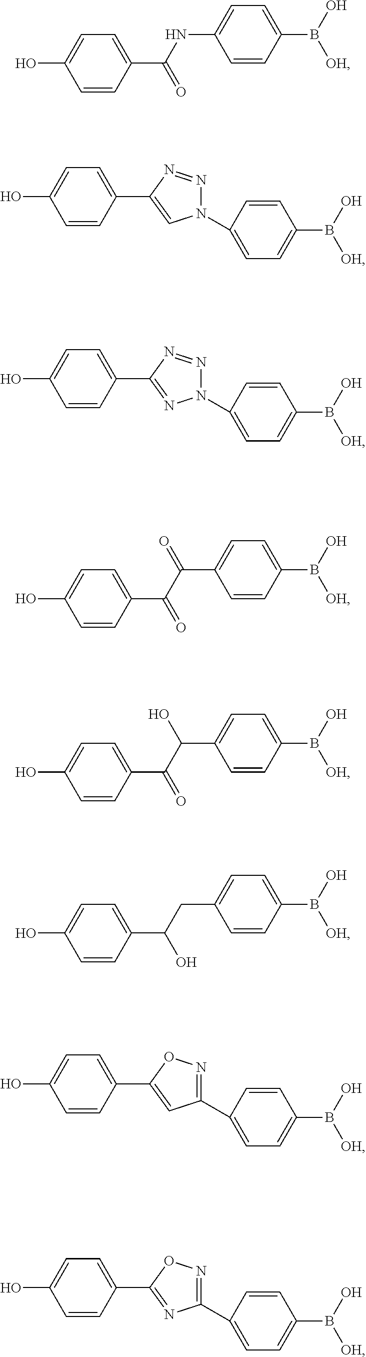

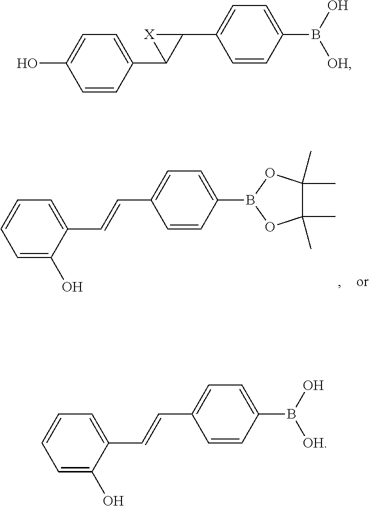

A compound having the structure:

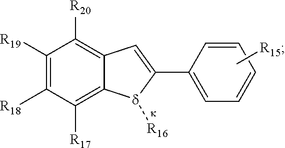

wherein R₁₅ is:

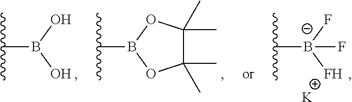

wherein the wavy line represents the point of attachment of R₁₅ to the aryl ring;
wherein atom δ is C, O, N, or S,
and when atom δ is O or S, bond κ and R₁₆ are absent; when atom δ is N, bond κ is present and R₁₆ is H, alkyl or aryl; when atom δ is C, bond κ is present and R₁₆ is H, alkyl or aryl; where R₁₇, R₁₈, R₁₉ and R₂₀ are, independently, —H, —OH, halogen, —OCH₃, —O—C₂H₂NH₂, C1-C6 alkyl, aryl, phenyl, heteroaryl, arylalkyl, heterocyclic, alkenyl, C2-C6 alkenyl, C2-C6 alkynyl, —NO₂, —OC₂H₅, —O-alkyl, —SH, —S-alkyl, —NH₂, or —NH-alkyl;
or pharmaceutically acceptable salt thereof or a stereoisomer thereof.

In an embodiment of the compound or pharmaceutically acceptable salt thereof, or stereoisomer thereof, R₁₇, R₁₈, R₁₉ and R₂₀ are, independently, —H, —OH, halogen, —OCH₃, —O—C₂H₂—NH₂, or —OC₂H₅.

In an embodiment the compound or pharmaceutically acceptable salt thereof, or stereoisomer thereof, has the structure:

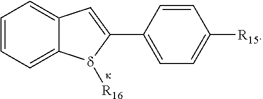

In an embodiment of the compound or pharmaceutically acceptable salt thereof, or stereoisomer thereof, when atom δ is N, bond κ is present and R₁₆ is H, a substituted or unsubstituted C1-C6 alkyl or a substituted or unsubstituted aryl.

In an embodiment of the compound or pharmaceutically acceptable salt thereof, or stereoisomer thereof, atom δ is S.

In an embodiment of the compound or pharmaceutically acceptable salt thereof, or stereoisomer thereof, atom δ is O.

In an embodiment of the compound or pharmaceutically acceptable salt thereof, or stereoisomer thereof, R₁₅ is:

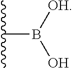 [SMILES: *B(O)O]

In an embodiment of the compound or pharmaceutically acceptable salt thereof, or stereoisomer thereof, R₁₅ is:

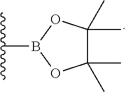 [SMILES: *B1OC(C)(C)C(C)(C)O1]

In an embodiment of the compound or pharmaceutically acceptable salt thereof, or stereoisomer thereof, R₁₅ is:

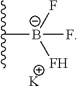 [SMILES: *[B-](F)(F)F ; [K+]]

In an embodiment the compound or pharmaceutically acceptable salt thereof, or stereoisomer thereof, has the structure:

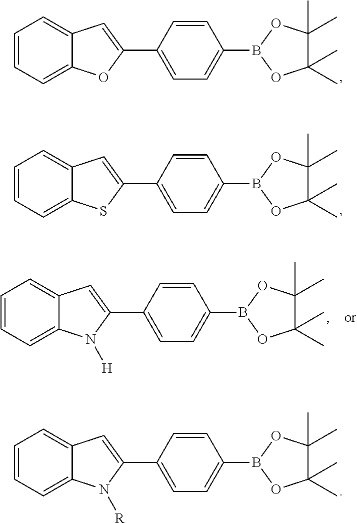

In an embodiment the compound or pharmaceutically acceptable salt thereof, or stereoisomer thereof, has the structure:

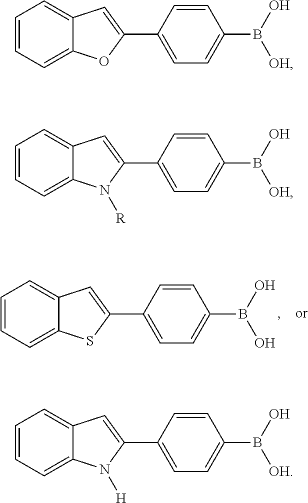

In an embodiment the compound or pharmaceutically acceptable salt thereof, or stereoisomer thereof, has the structure:

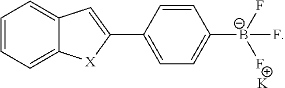

A compound having the structure:

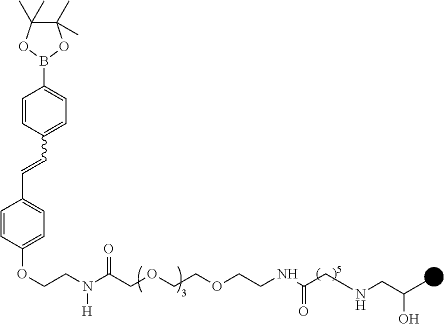

wherein the filled circle is a crosslinked, bead-formed agarose resin.

A composition, comprising of any one of the instant compounds, or pharmaceutically acceptable salt thereof, or stereoisomer thereof.

In an embodiment the composition comprises a pharmaceutically acceptable carrier.

In an embodiment of the composition the compound or pharmaceutically acceptable salt thereof or stereoisomer thereof has the structure:

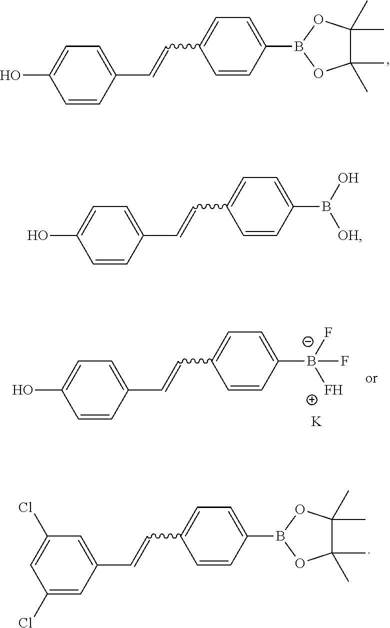 [SMILES: CC1(C)OB(c2ccc(C=Cc3ccc(O)cc3)cc2)OC1(C)C ; OB(O)c1ccc(C=Cc2ccc(O)cc2)cc1 ; Oc1ccc(C=Cc2ccc([B-](F)(F)[FH+])cc2)cc1 ; [K+] ; CC1(C)OB(c2ccc(C=Cc3cc(Cl)cc(Cl)c3)cc2)OC1(C)C]

A pharmaceutical composition comprising any of the instant compounds, or pharmaceutically acceptable salt thereof, or stereoisomer thereof, and a pharmaceutically acceptable carrier.

A method of treating a dyslipidemia in a subject comprising administering to the subject any of the instant compounds, or pharmaceutically acceptable salt thereof, or stereoisomer thereof, or the instant composition or pharmaceutical composition in an amount effective to treat the dyslipidemia in the subject. In an embodiment, the dyslipidemia results from obesity. In an embodiment, the dyslipidemia is excess fatty acid synthesis. In an embodiment, the dyslipidemia is excess cholesterol synthesis. In an embodiment, the subject has obesity, cardiovascular disease, type 2 diabetes, cancer or Alzheimer's disease.

A method of inhibiting fatty acid synthesis or cholesterol synthesis in a subject comprising administering to the subject any of the instant compounds, or pharmaceutically acceptable salt thereof, or stereoisomer thereof, or the instant composition or pharmaceutical composition in an amount effective to inhibit fatty acid synthesis or cholesterol synthesis in the subject.

A method of inhibiting a lipogenic enzyme or cholesterolgenic enzyme in a subject comprising administering to the subject any of the instant compounds, or pharmaceutically acceptable salt thereof, or stereoisomer thereof or the instant composition or pharmaceutical composition in an amount effective to inhibit the lipogenic enzyme or the cholesterolgenic enzyme in the subject.

A method treating a cancer in a subject comprising administering to the subject any of the instant compounds, or pharmaceutically acceptable salt thereof, or stereoisomer thereof, or the instant composition or pharmaceutical composition in an amount effective to treat the cancer in the subject.

The compounds of the present invention include all hydrates, solvates, and complexes of the compounds used by this invention. If a chiral center or another form of an isomeric center is present in a compound of the present invention, all forms of such isomer or isomers, including enantiomers and diastereomers, are intended to be covered herein. Compounds containing a chiral center may be used as a racemic mixture, an enantiomerically enriched mixture, or the racemic mixture may be separated using well-known techniques and an individual enantiomer may be used alone. The compounds described in the present invention are in racemic form or as individual enantiomers. The enantiomers can be separated using known techniques, such as those described in Pure and Applied Chemistry 69, 1469-1474, (1997) IUPAC (hereby incorporated by reference). In cases in which compounds have unsaturated carbon-carbon double bonds, both the cis (Z) trans (E) isomers are within the scope of this invention. In cases wherein compounds may exist, in tautomeric, forms, such as keto-enol tautomers, each tautomeric form is contemplated as being included within this invention whether existing in equilibrium or predominantly in one form.

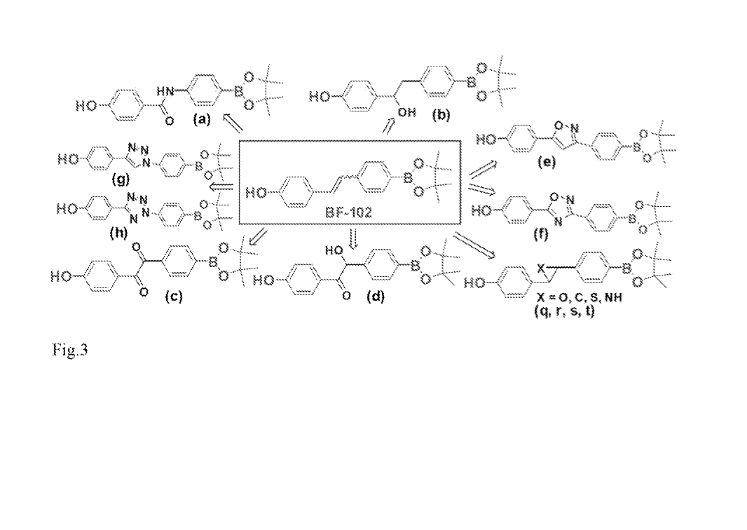

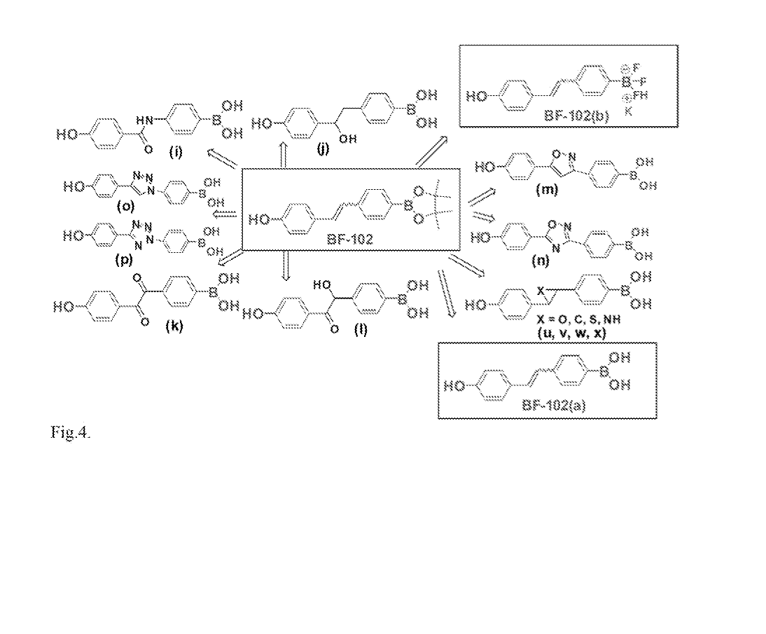

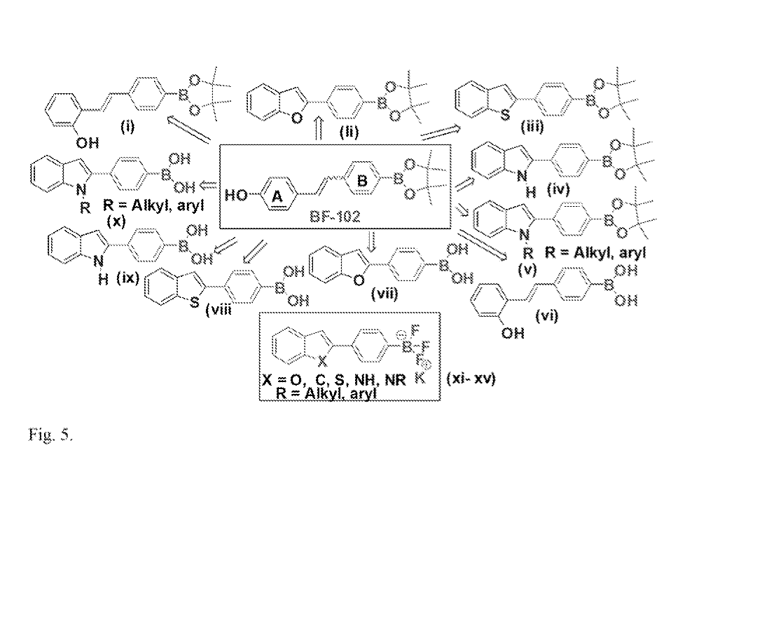

Compounds shown in FIGS. 3-5 derived from the lead compound can be synthesized from the lead compound by standard techniques in the art, for example see Modern Organic Synthesis in the Laboratory, Oxford University Press, USA (Sep. 10, 2007), Madison Ave, N.Y. (ISBN-10: 0195187989) which is hereby incorporated by reference.

When the structure of the compounds of this invention includes an asymmetric carbon atom such compound can occur as racemates, racemic mixtures, and isolated single enantiomers. All such isomeric forms of these compounds are expressly included in this invention. Each stereogenic carbon may be of the R or S configuration. It is to be understood accordingly that the isomers arising from such asymmetry (e.g., all enantiomers and diastereomers) are included within the scope of this invention, unless indicated otherwise. Such isomers can be obtained in substantially pure form by classical separation techniques and by stereochemically controlled synthesis, such as those described in “Enantiomers, Racemates and Resolutions” by J. Jacques, A. Collet and S. Wilen, Pub. John Wiley & Sons, NY, 1981 (hereby incorporated by reference). For example, the resolution may be carried out by preparative chromatography on a chiral column.

The subject invention is also intended to include all isotopes of atoms occurring on the compounds disclosed herein. Isotopes include those atoms having the same atomic number but different mass numbers. By way of general example and without limitation, isotopes of hydrogen include tritium and deuterium. Isotopes of carbon include carbon-13 and carbon-14.

It will be noted that any notation of a carbon in structures throughout this application, when used without further notation, are intended to represent all isotopes of carbon, such as 12C, 13C, or 14C. Furthermore, any compounds containing 13C or 14C may specifically have the structure of any of the compounds disclosed herein.

It will also be noted that any notation of a hydrogen in structures throughout this application, when used without further notation, are intended to represent all isotopes of hydrogen, such as 1H, 2H, or 3H. Furthermore, any compounds containing 2H or 3H may specifically have the structure of any of the compounds disclosed herein.

Isotopically-labeled compounds can generally be prepared by conventional techniques known to those skilled in the art or by processes analogous to those described in the Examples disclosed herein using an appropriate isotopically-labeled reagents in place of the non-labeled reagents employed.

As used herein, “alkyl” includes both branched and straight-chain saturated aliphatic hydrocarbon groups having the specified number of carbon atoms and may be unsubstituted or substituted, unless specified otherwise. Thus, C1-Cn as in “C1-Cn alkyl” is defined to include groups having 1, 2, . . . , n−1 or n carbons in a linear or branched arrangement. For example, C1-C6, as in “C1-C6 alkyl” is defined to include groups having 1, 2, 3, 4, 5, or 6 carbons in a linear or branched arrangement, and specifically includes methyl, ethyl, n-propyl, isopropyl, n-butyl, t-butyl, pentyl, and hexyl. “Alkenyls” and “alkynyls” are understood similarly, mutatis mutandis, with alkenyls and alkynyls necessarily having a minimum of 2 C atoms, and a minimum of one double or one triple bond, respectively.

Where a numerical range is provided herein, it is understood that all chemically possible numerical subsets of that range, and all the individual integers contained therein, are provided as part of the invention. Thus, a C2-C6 alkenyl includes the subset of alkenyls which are C2-C5, and the subset which is C2-C4 etc. as well as a C5 alkenyl, a C3 alkenyl, a C6 alkenyl etc.

As used herein, “aryl” is intended to mean any stable monocyclic, bicyclic or polycyclic carbon ring of up to 10 atoms in each ring, wherein at least one ring is aromatic, and may be unsubstituted or substituted. Examples of such aryl elements include phenyl, p-toluenyl (4-methylphenyl), naphthyl, tetrahydro-naphthyl, indanyl, biphenyl, phenanthryl, anthryl or acenaphthyl. In cases where the aryl substituent is bicyclic and one ring is non-aromatic, it is understood that attachment is via the aromatic ring.

The term “substituted” refers to a functional group as described above in which one or more bonds to a hydrogen atom otherwise contained therein are replaced by a bond to non-hydrogen or non-carbon atoms, provided that normal valencies are maintained and that the substitution results in a stable compound. Substituted groups also include groups in which one or more bonds to a carbon (s) or hydrogen (s) atom are replaced by one or more bonds, including double or triple bonds, to a heteroatom. Examples of substituent groups include the functional groups described herein, and, in particular, halogens (i.e., F, Cl, Br, and I); alkyl groups, such as methyl, ethyl, n-propyl, isopropryl, n-butyl, tert-butyl, and trifluoromethyl; hydroxyl; alkoxy groups, such as methoxy, ethoxy, n-propoxy, and isopropoxy; aryloxy groups, such as phenoxy; arylalkyloxy, such as benzyloxy(phenylmethoxy) and p-trifluoromethylbenzyloxy(4-trifluoromethylphenylmethoxy); heteroaryloxy groups; sulfonyl groups, such as trifluoromethanesulfonyl, methanesulfonyl, and p-toluenesulfonyl; nitro, nitrosyl; mercapto; sulfanyl groups, such as methylsulfanyl, ethylsulfanyl and propylsulfanyl; cyano; amino groups, such as amino, methylamino, dimethylamino, ethylamino, and diethylamino; and carboxyl. Where multiple substituent moieties are disclosed or claimed, the substituted compound can be independently substituted by one or more of the disclosed or claimed substituent moieties, singly or plurally. By independently substituted, it is meant that the (two or more) substituents can be the same or different.

It is understood that substituents and substitution patterns on the compounds of the instant invention can be selected by one of ordinary skill in the art to provide compounds that are chemically stable and that can be readily synthesized by techniques known in the art, as well as those methods set forth below, from readily available starting materials. If a substituent is itself substituted with more than one group, it is understood that these multiple groups may be on the same carbon or on different carbons, so long as a stable structure results.

In choosing the compounds of the present invention, one of ordinary skill in the art will recognize that the various substituents, i.e. R1, R2, etc. are to be chosen in conformity with well-known principles of chemical structure connectivity.

The various R groups attached to the aromatic rings of the compounds disclosed herein may be added to the rings by standard procedures, for example those set forth in Advanced Organic Chemistry: Part B: Reaction and Synthesis, Francis Carey and Richard Sundberg, (Springer) 5th ed. Edition. (2007), the content of which is hereby incorporated by reference.

The compounds of the instant invention may be in a salt form. As used herein, a “salt” is salt of the instant compounds which has been modified by making acid or base, salts of the compounds. In the case of compounds used for treatment of dyslipidemias and associated pathologies, the salt is pharmaceutically acceptable. Examples of pharmaceutically acceptable salts include, but are not limited to, mineral or organic acid salts of basic residues such as amines; alkali or organic salts of acidic residues such as phenols. The salts can be made using an organic or inorganic acid. Such acid salts are chlorides, bromides, sulfates, nitrates, phosphates, sulfonates, formates, tartrate, maleates, malates, citrates, benzoates, salicylates, ascorbates, and the like. Phenolate salts are the alkaline earth metal salts, sodium, potassium or lithium. The term “pharmaceutically acceptable salt” in this respect, refers to the relatively non-toxic, inorganic and organic acid or base addition salts of compounds of the present invention. These salts can be prepared in situ during the final isolation and purification of the compounds of the invention, or by separately reacting a purified compound of the invention in its free base or free acid form with a suitable organic or inorganic acid or base, and isolating the salt thus formed. Representative salts include the hydrobromide, hydrochloride, sulfate, bisulfate, phosphate, nitrate, acetate, valerate, oleate, palmitate, stearate, laurate, benzoate, lactate, phosphate, tosylate, citrate, maleate, fumarate, succinate, tartrate, napthylate, mesylate, glucoheptonate, lactobionate, and laurylsulphonate salts and the like. (See, e.g., Berge et al. (1977) “Pharmaceutical Salts”, J”. Pharm. Sci. 66:1-19 the content of which is hereby incorporated by reference).

The compositions of this invention may be administered in various forms, including those detailed herein. The treatment with the compound may be a component of a combination therapy or an adjunct therapy, i.e. the subject or patient in need of the drug is treated or given another drug for the disease (e.g. a statin) in conjunction with one or more of the instant compounds. This combination therapy can be sequential therapy where the patient is treated first with one drug and then the other or the two drugs are given simultaneously. These can be administered independently by the same route or by two or more different routes of administration depending on the dosage forms employed.

As used herein, a “pharmaceutically acceptable carrier” is a pharmaceutically acceptable solvent, suspending agent or vehicle, for delivering the instant compounds to the animal or human. The carrier may be liquid or solid and is selected with the planned manner of administration in mind. Liposomes are also a pharmaceutically acceptable carrier.

The dosage of the compounds administered in treatment will vary depending upon factors such as the pharmacodynamic characteristics of a specific chemotherapeutic agent and its mode and route of administration; the age, sex, metabolic rate, absorptive efficiency, health and weight of the recipient; the nature and extent of the symptoms; the kind of concurrent treatment being administered; the frequency of treatment with; and the desired therapeutic effect.

A dosage unit of the compounds may comprise a single compound or mixtures thereof with anti-lipogenic compounds. The compounds can be administered in oral dosage forms as tablets, capsules, pills, powders, granules, elixirs, tinctures, suspensions, syrups, and emulsions. The compounds may also be administered in intravenous (bolus or infusion), intraperitoneal, subcutaneous, or intramuscular form, or introduced directly, e.g. by injection or other methods, into the cancer, all using dosage forms well known to those of ordinary skill in the pharmaceutical arts.

The compounds can be administered in admixture with suitable pharmaceutical diluents, extenders, excipients, or carriers (collectively referred to herein as a pharmaceutically acceptable carrier) suitably selected with respect to the intended form of administration and as consistent with conventional pharmaceutical practices. The unit will be in a form suitable for oral, rectal, topical, intravenous or direct injection or parenteral administration. The compounds can be administered alone but are generally mixed with a pharmaceutically acceptable carrier. This carrier can be a solid or liquid, and the type of carrier is generally chosen based on the type of administration being used. In one embodiment the carrier can be a monoclonal antibody. The active agent can be coadministered in the form of a tablet or capsule, liposome, as an agglomerated powder or in a liquid form. Examples of suitable solid carriers include lactose, sucrose, gelatin and agar. Capsule or tablets can be easily formulated and can be made easy to swallow or chew; other solid forms include granules, and bulk powders. Tablets, may contain suitable binders, lubricants, diluents, disintegrating agents, coloring agents, flavoring agents, flow-inducing agents, and melting agents. Examples of suitable liquid dosage forms include solutions or suspensions in water, pharmaceutically acceptable fats and oils, alcohols or other organic solvents, including esters, emulsions, syrups or elixirs, suspensions, solutions and/or suspensions reconstituted from non-effervescent granules and effervescent preparations reconstituted from effervescent granules. Such liquid dosage forms may contain, for example, suitable solvents, preservatives, emulsifying agents, suspending agents, diluents, sweeteners, thickeners, and melting agents. Oral dosage forms optionally contain flavorants and coloring agents. Parenteral and intravenous forms may also include minerals and other materials to make them compatible with the type of injection or delivery system chosen.

Examples of pharmaceutical acceptable carriers and excipients that may be used to formulate oral dosage forms of the present invention are described in U.S. Pat. No. 3,903,297 to Robert, issued Sep. 2, 1975. Techniques and compositions for making dosage forms useful in the present invention are described-in the following references: 7 Modern Pharmaceutics, Chapters 9 and 10 (Banker & Rhodes, Editors, 1979); Pharmaceutical Dosage Forms Tablets (Lieberman et al., 1981); Ansel, Introduction to Pharmaceutical Dosage Forms 2nd Edition (1976); Remington's Pharmaceutical Sciences, 17th ed. (Mack Publishing Company, Easton, Pa., 1985); Advances in Pharmaceutical Sciences (David Ganderton, Trevor Jones, Eds., 1992); Advances in Pharmaceutical Sciences Vol 7. (David Ganderton, Trevor Jones, James McGinity, Eds., 1995); Aqueous Polymeric Coatings for Pharmaceutical Dosage Forms (Drugs and the Pharmaceutical Sciences, Series 36 (James McGinity; Ed., 1989); Pharmaceutical Particulate Carriers: Therapeutic Applications: Drugs and the Pharmaceutical Sciences, Vol 61 (Alain Rolland, Ed., 1993); Drug Delivery to the Gastrointestinal Tract (Ellis Horwood Books in the Biological Sciences. Series in Pharmaceutical Technology; J. G. Hardy, S. S. Davis, Clive G. Wilson, Eds.); Modern Pharmaceutics Drugs and the Pharmaceutical Sciences, Vol 40 (Gilbert S. Banker, Christopher T. Rhodes, Eds.). All of the aforementioned publications are incorporated by reference herein.

Tablets may contain suitable binders, lubricants, disintegrating agents, coloring agents, flavoring agents, flow-inducing agents, and melting agents. For instance, for oral administration in the dosage unit form of a tablet or capsule, the active drug component can be combined with an oral, non-toxic, pharmaceutically acceptable, inert carrier such as lactose, gelatin, agar, starch, sucrose, glucose, methyl cellulose, magnesium stearate, dicalcium phosphate, calcium sulfate, mannitol, sorbitol and the like. Suitable binders include starch, gelatin, natural sugars such as glucose or beta-lactose, corn sweeteners, natural and synthetic gums such as acacia, tragacanth, or sodium alginate, carboxymethylcellulose, polyethylene glycol, waxes, and the like. Lubricants used in these dosage forms include sodium oleate, sodium stearate, magnesium stearate, sodium benzoate, sodium acetate, sodium chloride, and the like. Disintegrators include, without limitation, starch, methyl cellulose, agar, bentonite, xanthan gum, and the like.

The compounds can also be administered in the form of liposome delivery systems, such as small unilamellar vesicles, large unilamallar vesicles, and multilamellar vesicles. Liposomes can be formed from a variety of phospholipids, such as cholesterol, stearylamine, or phosphatidylcholines. The compounds may be administered as components of tissue-targeted emulsions.

The compounds may also be coupled to soluble polymers as targetable drug carriers or as a prodrug. Such polymers include polyvinylpyrrolidone, pyran copolymer, polyhydroxylpropylmethacrylamide-phenol, polyhydroxyethylasparta-midephenol, or polyethyleneoxide-polylysine substituted with palmitoyl residues. Furthermore, the compounds may be coupled to a class of biodegradable polymers useful in achieving controlled release of a drug, for example, polylactic acid, polyglycolic acid, copolymers of polylactic and polyglycolic acid, polyepsilon caprolactone, polyhydroxy butyric acid, polyorthoesters; polyacetals, polydihydropyrans, polycyanoacylates, and crosslinked or amphipathic block copolymers of hydrogels.

The active ingredient can be administered orally in solid dosage forms, such as capsules, tablets, and powders, or in liquid dosage forms, such as elixirs, syrups, and suspensions. It can also be administered parentally, in sterile liquid dosage forms.

Gelatin capsules may contain the active ingredient compounds and powdered carriers, such as lactose, starch, cellulose derivatives, magnesium stearate, stearic acid, and the like. Similar diluents can be used to make compressed tablets. Both tablets and capsules can be manufactured as immediate release products or as sustained release products to provide for continuous release of medication over a period of hours. Compressed tablets can be sugar coated or film coated to mask any unpleasant taste and protect the tablet from the atmosphere, or enteric coated for selective disintegration in the gastrointestinal tract.

For oral administration in liquid dosage form, the oral drug components are combined with any oral, non-toxic, pharmaceutically acceptable inert carrier such as ethanol, glycerol, water, and the like. Examples of suitable liquid dosage forms include solutions or suspensions in water, pharmaceutically acceptable fats and oils, alcohols or other organic solvents, including esters, emulsions, syrups or elixirs, suspensions, solutions and/or suspensions reconstituted from non-effervescent granules and effervescent preparations reconstituted from effervescent granules. Such liquid dosage forms may contain, for example, suitable solvents, preservatives, emulsifying agents, suspending agents, diluents, sweeteners, thickeners, and melting agents.

Liquid dosage forms for oral administration can contain coloring and flavoring to increase patient acceptance. In general, water, a suitable oil, saline, aqueous dextrose (glucose), and related sugar solutions and glycols such as propylene glycol or polyethylene glycols are suitable carriers for parenteral solutions. Solutions for parenteral administration preferably contain a water soluble salt of the active ingredient, suitable stabilizing agents, and if necessary, buffer substances. Antioxidizing agents such as sodium bisulfite, sodium sulfite, or ascorbic acid, either alone or combined, are suitable stabilizing agents. Also used are citric acid and its salts and sodium EDTA. In addition, parenteral solutions can contain preservatives, such as benzalkonium chloride, methyl- or propyl-paraben, and chlorobutanol. Suitable pharmaceutical carries are described in Remington's Pharmaceutical Sciences, Mack Publishing Company, a standard reference text in this field, the content of which is hereby incorporated by reference.

The compounds of the instant invention may also be administered in intranasal form via use of suitable intranasal vehicles, or via transdermal routes, using those forms of transdermal skin patches well known to those of ordinary skill in that art. To be administered in the form of a transdermal delivery system, the dosage administration will generally be continuous rather than intermittent throughout the dosage regimen. Parenteral and intravenous forms may also include minerals and other materials to make them compatible with the type of injection or delivery system chosen.

The compounds and compositions of the invention can be coated onto stents for temporary or permanent implantation into the cardiovascular system of a subject.

The compounds and compositions disclosed herein are useful in treating dyslipidemias, treating obesity an inhibiting lipogenesis and/or cholesterolgenesis.

As used herein, a “dyslipidemia” is an abnormal amount of lipids (e.g. cholesterol and/or fat) in the blood. Dyslipidemia is elevation of plasma cholesterol, triglycerides (TGs), or both, or a low high-density lipoprotein level that contributes to the development of atherosclerosis. Causes may be primary (genetic) or secondary. Diagnosis is by measuring plasma levels of total cholesterol, TGs, and individual lipoproteins. Dyslipidemias are medically-recognized (see The Merck Manual of Diagnosis and Therapy, 18^{th} Edition, Merck Publishing, ISBN-10: 0911910182, the content of which is hereby incorporated by reference). In an embodiment the dyslipidemia results in or is caused by obesity in the subject. In an embodiment the obesity is caused by a high fat diet. In an embodiment the dyslipidemia is excess fatty acid synthesis. In an embodiment the dyslipidemia is excess cholesterol synthesis.

To “treat” a dyslipidemia as used herein means to reduce, ameliorate, arrest or reverse one or more symptoms of the dyslipidemia.

Also provided is a method of synthesizing a boron-containing stilbene derivative comprising contacting a compound having the structure:

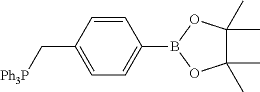

with a compound having the structure:

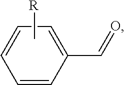

where R represents one or more desired substitutents, for example any one or more of R₂, R₃, R₄, R₅, and R₆ set forth hereinabove in the presence of a suitable solvent and sodium tert-butoxide so as to form the boron-containing stilbene derivative. In an embodiment, the suitable solvent is DMF.

Also provided is a process for making any of the instant compounds, comprising contacting a compound having the structure:

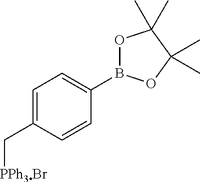

with a strong base and an aldehyde and a suitable solvent under conditions permitting the formation of the compound.

In an embodiment, the strong base is a non-nucleophilic base. In a preferred embodiment, the strong base is sodium tert-butoxide. In an embodiment, the suitable solvent is DMF. In an embodiment, the conditions permitting the formation of the compound comprise performing the reaction at room temperature. Room temperature is 20 to 25 degrees Celsius. In an embodiment, the reaction is performed under a nitrogen atmosphere. In an embodiment, the aldehyde is an aryl aldehyde. In an embodiment, the aldehyde is an α,β-unsaturated aldehyde. In an embodiment, the aldehyde is one of the aldehydes set forth in Table 1.

Also provided is a method of synthesizing a compound having the structure:

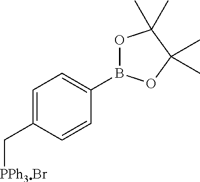

comprising contacting a compound having the structure:

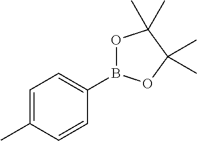

with NBS (N-Bromosuccinimide) aid AIBN (Azobisisobutyronitrile) in a first suitable solvent so as to form a product having the structure:

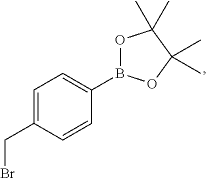 [SMILES: CC1(C)OB(c2ccc(CBr)cc2)OC1(C)C]

then contacting the product with PPh₃.Br in a second suitable solvent so as to form the compound having the structure:

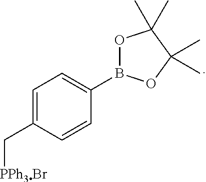

In an embodiment the first suitable solvent is CCl₄. In an embodiment the second suitable solvent is CH₃CN.

All combinations of the various elements described herein are within the scope of the invention unless otherwise indicated herein or otherwise clearly contradicted by context.

This invention will be better understood from the Experimental Details, which follow. However, one skilled in the art will readily appreciate that the specific methods and results discussed are merely illustrative of the invention as described more fully in the claims that follow thereafter.

### EXPERIMENTAL DETAILS

### Preparation of Chemical Compounds

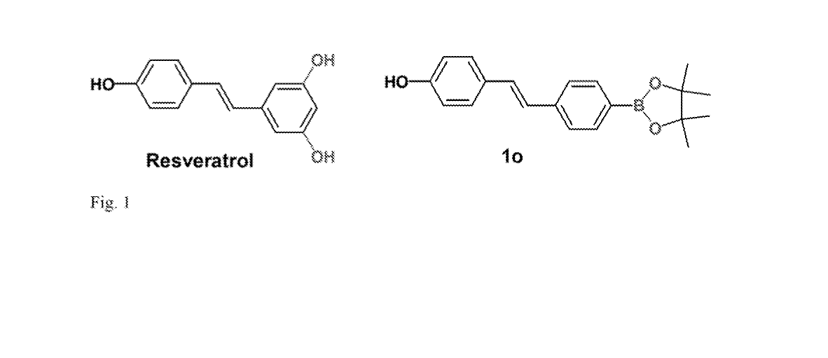

A synthetic methodology was developed to synthesize boron-containing stilbene derivatives and this methodology was used to synthesize target compound 10 (i.e. BF-102) (FIG. 1).

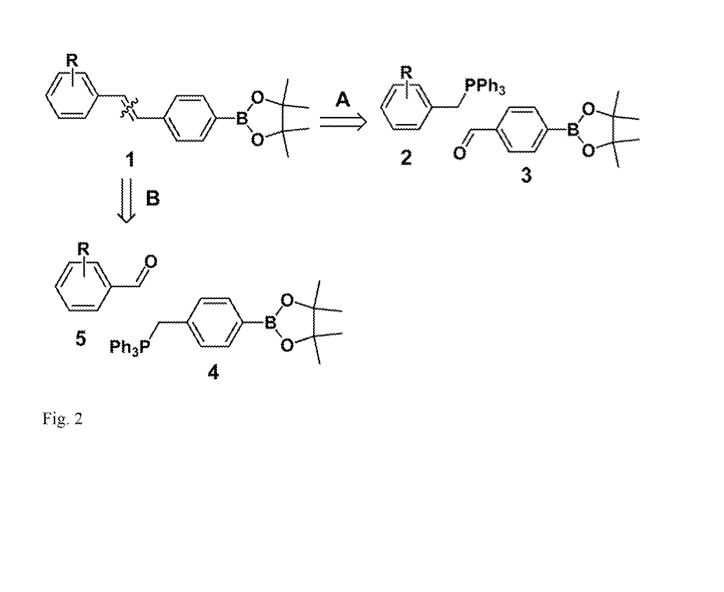

The most familiar and general strategy for synthesis of boron-containing stilbenes 1 is based on disconnection A (FIG. 2) and involves the Wittig reaction of the various substituted benzyl phosphoniumylide 2 with the pinacol ester of boronate aldehyde 3 (4). A literature search failed to uncover any examples of pinacol ester of boronato phosphoniumylide. Herein is disclosed the employment of this strategy to prepare novel pinacolylboronate-substituted stilbene derivatives is disclosed. Although Wittig and Horner-Wadsworth-Emmons reactions have been carried out on aldehyde derivatives of boronate esters (5, 6, 7) the problem with this approach A (FIG. 2) to synthesize boron-containing stilbene derivatives requires various substituted benzyl phosphonium ylides and boron containing aldehydes. Boron-containing aldehydes are very prone to self-dimerization and oxidation and decomposed for longer storage, so this method is limited in scope. To overcome this problem, the disconnection B approach (FIG. 2) was used, envisaging the use of the pinacol ester of boronato phosphonium ylide 4, which has not previously been explored.

The present methodology is more practically applicable because it contains boronic esters and acids which are biological active. Because there is no dearth of pinacol esters of boronato phosphonium ylide 4 in the literature, the route appeared highly attractive. Compound 4 is stable in air, so different phenyl and alkyl aldehydes are easily available or can be derivatized to synthesize a library of boron-containing stilbene derivatives. Herein is disclosed the success of this new route based on disconnection B (FIG. 1), the preparation of pinacol ester of boronato phosphonium ylide 4, followed by the novel synthesis of pinacolylboronate-substituted stilbene derivatives via the direct Wittig bromide (4) from the corresponding 2-[4/-(bromomethyl)phenyl]-4,4,5,5-tetramethyl-1,3,2-dioxaborolane 6 in the presence of 1.01 equiv of triphenylphosphine in acetonitrile at reflux condition (Scheme 1):

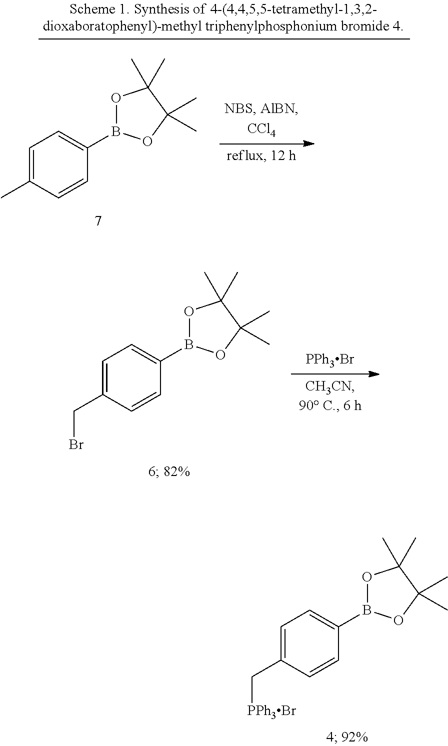

Compound 6 (8) was prepared starting from 4,4,5,5-tetramethyl-2-p-tolyl-1,3,2-dioxaborolane 7, NBS and AIBN in carbon tetrachloride were refluxed for 12 hours. In an initial attempt 4-(4,4,5,5-tetramethyl-1,3,2-dioxaboratophenyl)-methyl triphenylphosphonium bromide 4 was isolated as a white solid in 92% yield. The minor excess of PPh₃ was removed from the product by trituration with ether 2-3 times and the product was found to be stable under normal atmospheric conditions. Subsequently, the Wittig reaction of the ylide derived from this salt using benzaldehyde (Scheme 2) was optimized.

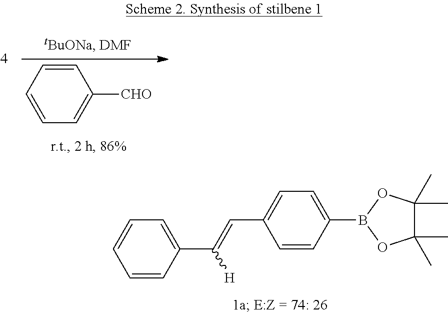 [SMILES: O=Cc1ccccc1 ; CC1(C)OB(c2ccc(C=Cc3ccccc3)cc2)OC1(C)C]

It is noteworthy that the three equivalents of sodium tert-butoxide in DMF at room temperature led to the highest yield of 1a (see Table 1, entry 1). With this optimized condition in hand, the scope of the Wittig reaction was examined for the synthesis of pinacolylboronate-substituted stilbenes using various aryl aldehydes. The results are summarized in Table 1. All the compounds were fully characterized (1H NMR, 13C NMR and HRMS).

General Procedure for the Synthesis of Stilbenes (Table 1).

A flask equipped with a magnetic stirring bar and a septum inlet was charged with 4-(4,4,5,5-tetramethyl-1,3,2-dioxaboratophenyl)-methyl triphenylphosphonium bromide (4) (1 mmol), dry DMF (5 mL), and tBuONa (3 mmol) under nitrogen. The mixture was stirred at room temperature for 5-10 min. To this solution was added aldehyde (1 mmol) and the resulting mixture was then stirred at room temperature for 4-6 h. The reaction mixture was treated with water (20 mL) and neutralized with 1 M HCl and the product was extracted with ethyl acetate (3×10 mL) washed with brine and dried over Na₂SO₄. The product was isolated by chromatography over silica gel.

4-(4,4,5,5-Tetramethyl-1,3,2-dioxaborolan-2-yl)stilbene (1a). 1H NMR (300 MHz, CDCl₃): δ 1.36 (s), 1.38 (s), 6.59-6.68 (m), 7.10-7.30 (m), 7.33-7.40 (m), 7.50-7.58 (m), 7.67-7.70 (d, J=9 Hz), 7.81-7.84 (d, J=9 Hz). 13C NMR (75 MHz, CDCl₃): δ 25.3, 84.2, 126.2, 127.0, 127.6, 128.6, 129.1, 129.3, 130.6, 131.3, 135.1, 135.6, 137.5, 137.6, 139.5, 140.0. HRMS (ESI): m/z calcd. for C₂₀H₂₃BO₂ [M+Na]+ 329.1689. found-329.1684.

4-Carboxyl-4/-(4,4,5,5-Tetramethyl-1,3,2-dioxaborolan-2-yl)stilbene (1d). 1H NMR (300 MHz, CDCl₃): δ 1.36 (s), 1.38 (s), 6.62-6.81 (m), 7.23-7.26 (d, J=9 Hz), 7.33-7.36 (d, J=9 Hz), 7.51-7.68 (m), 7.69-7.72 (d, J=9 Hz), 7.82-7.87 (m), 7.94-7.98 (d, J=12 Hz), 8.08-8.20 (m). 13C NMR (75 MHz, CDCl₃): δ 25.3, 84.4, 1267, 127.0, 128.1, 128.6, 129.5, 130.3, 130.8, 131.2, 132.0, 133.1, 135.2, 135.8, 140.0, 143.3. HRMS (ESI) m/z calcd. for C₂₁H₂₃BO₄ [M-H]+349.1611. found 349.1630.

4,4,5,5-Tetramethyl-2-[4-(2-thiophen-2-yl-vinyl)-phenyl]-[1,3,2]dioxaborolane (1i). 1H NMR (300 MHz, CDCl₃): δ 1.38 (s), 6.57-6.61 (d, J=12 Hz), 6.70-6.75 (d, J=15 Hz), 6.86-6.92 (m), 6.96-7.05 (m), 7.08-7.11 (m), 7.22-7.24 (d, J=6 Hz), 7.28-7.30 (d, J=6 Hz), 7.34 (s), 7.39-7.42 (d, J=9 Hz), 7.48-7.51 (d, J=9 Hz), 7.80-7.83 (d, J=9 Hz). 13C NMR (75 MHz, CDCl₃): δ 25.3, 84.2, 123.1, 125.1, 125.9, 126.8, 128.1, 128.6, 135.3, 135.6, 140.1, 143.2. HRMS (ESI): m/z calcd. for C₁₈H₂₁BO₂S [M+Na]+ 335.1253. found 335.1261.

4,4,5,5-Tetramethyl-2-[4-(4-phenyl-buta-1,3-dienyl)-phenyl]-[1,3,2]dioxaborolane (1j). 1H NMR (300 MHz, CDCl₃): δ 1.38 (s), 1.39 (s), 6.41-6.58 (m), 6.65-6.80 (m), 6.94-7.10 (m), 7.20-7.31 (m), 7.31-7.45 9m), 7.46-7.48 (d, J=6 Hz), 7.79-7.82 (d, J=9 Hz), 7.85-7.88 (d, J=9 Hz). 13C NMR (75 MHz, CDCl₃): δ 25.3, 84.2, 126.1, 126.8, 127.0, 128.1, 128.7, 129.1, 129.6, 130.7, 133.2, 133.8, 135.2, 135.5, 137.7, 140.5140.8. HRMS (ESI): m/z calcd. for C₂₂H₂₅BO₂ [M+Na]+ 355.1845. found 355.1845.

4-{2-[4-(4,4,5,5-Tetramethyl-[1,3,2]dioxaborolan-2-yl)-phenyl]-vinyl}-phenol (1l). BF-102: 1H NMR (300 MHz, CDCl₃): δ 1.37 (s), 5.02 (bs), 6.72-6.75 (d, J=9 Hz), 6.82-6.86 (d, J=12 Hz), 6.94-6.98 (d, J=12 Hz), 7.10-7.29 (m), 4.41-7.45 (d, J=12 Hz), 7.48-7.56 (m), 7.75-7.83 (m), 7.96-7.80 (d, J=12 Hz). 13C NMR (75 MHz, CDCl₃): δ 25.3, 84.2, 112.6, 116.1, 125.9, 126.3, 126.9, 127.8, 128.5, 129.5, 129.9, 130.6, 132.1, 135.6, 140.3, 140.7, 155.8. HRMS (ESI): m/z calcd. for C₂₀H₃₃BO₃ [M-H]+ 321.1662. found 321.1683.

Synthesis of compound 9: Benzene-1,4-dicarbaldehyde 8 (0.05 g, 0.37 mmol) was added to a solution of 4(4,4,5,5-tetramethyl-1,3,2-dioxaboratophenyl)-methyl triphenylphosphonium bromide (4) (0.417 g, 0.74 mmol) in anhydrous DMF (10 mL) under nitrogen atmosphere. Sodium tertbutanolate (0.214 g, 2.23 mmol) was added to the clear solution at room temperature, and the mixture was stirred for 2 h. The reaction mixture was poured into water (30 mL) and neutralized with 1 M HCl. Then the resulting mixture was extracted by EtOAc (3×10 mL), washed with H₂O and brine, dried over anhydrous Na₂SO4 and filtered. Evaporation of the solvent followed by column chromatography on silica gel to obtain the pure product 9. Yield: 0.169 g (85%). 1H NMR (300 MHz, CDCl₃): δ 1.35 (s), 1.36 (s), 1.37 (s), 1.38 (s), 6.57-6.59 (d, J=6 Hz), 6.62 (s), 7.10-7.13 (m), 7.16-7.20 (m), 7.21-7.30 (m), 7.36-7.39 (d, J=9 Hz), 7.44-7.60 (m), 7.65-7.75 (m), 7.80-7.88 (m). 13C NMR (75 MHz, CDCl3): δ 25.3, 84.4, 126.2, 127.0, 127.8, 128.3, 128.9, 129.0, 129.3, 129.8, 131.0, 132.5, 132.6, 133.4, 135.1, 136.0, 140.2, 140.8. HRMS (ESI): m/z calcd. for C₃₄H₄₀B₂O₄ [M+Na]+ 557.3010. found 557.2982.

3,5-dichloro-4/-(4,4,5,5-Tetramethyl-1,3,2-dioxaborolan-2-yl)stilbene (1e). MD131 3,5-Dichloro-2-hydroxy-benzaldehyde (0.1 g, 0.571 mmol) was added to a solution of 4-(4,4,5,5-tetramethyl-1,3,2-doxaboratophenyl)-methyl triphenylphosphonium bromide (4) (0.319 g, 0.571 mmol) in anhydrous DMF (10 mL) under nitrogen atmosphere. Sodium tertbutanolate (6.164 g, 1.71 mmol) was added to the clear solution at room temperature, and the mixture was stirred for 12 h. The reaction mixture was poured into water (20 mL) and neutralized with 1 M HCl. Then the resulting mixture was extracted by EtOAc (3×10 mL), washed with H₂O and brine, dried over anhydrous Na₂SO₄ and filtered. Evaporation of the 1e solvent followed by column chromatography on silica gel to obtain the pure product as a mixture of E/Z. Yield: 0.176 g (82%). 1H NMR (300 MHz, CDCl₃): δ 1.36 (s), 1.38 (s), 6.45-6.49 (d, J=12 Hz), 6.66-6.71 (d, J=15 Hz), 7.11 (s), 7.12-7.15 (m), 7.18-7.25 (m), 7.40-7.7.43 (d, J=9 Hz), 7.48-7.53 (d, J=15 Hz); 7.68-7.76 (m), 7.81-7.86 (d, J=15 Hz). 13C NMR (75 MHz, CDCl₃): δ 25.3, 84.3, 125.3, 126.5, 127.6, 127.8, 128.5, 128.9, 132.8, 133.0, 133.2, 135.3, 135.7, 139.8, 140.2.

The reaction proved tolerant of both electron-withdrawing groups (p-NO₂, p-CO₂Me; Table 1, entries 1 and 3) and electron-donating groups (p-F, Table 1, entry 2) on the phenyl ring of the aldehyde. Interestingly, methyl-4-formyl benzoate as a substrate was directly converted to the corresponding boron containing stilbene carboxylic acid 1d in good yield (Table 1, entry 3). Also, the symmetrically-substituted boron-containing stilbene 1e was synthesized in good yield (Table 1, entry 4). Most surprisingly, 4-formylphenyl boronic acid (Table 1, entry 5) gives corresponding product 1f (one side pinacolylboronate and other side free boronic acid). The functionalized salicyldehydes also react well with the 8 and yielded the corresponding highly pinacolylboronate-substituted stilbenes with good yields (Table 1, entries 6, 7). Though the stereo selectivity (E-Z) is good to moderate, but changing substrates, base and solvent may increase the selectivity. To get good stereoselectivity, we tried with different aryl aldehydes containing a heteroatom such sulfur (Table 1, entries 8), the desired products were obtained in good yield. In addition to the aromatic aldehydes, α,β-unsaturated aldehydes (Table 1, entries 9 and 10) also reacted successfully and the corresponding conjugated diene functionalized boronic esters 1j and 1k were isolated in good yield. This method is versatile and tolerant to all substrates and reaction conditions.

TABLE 1
Wittig reaction of 4-(4,4,5,5-tetramethyl-1,3,2-dioxaboratophenyl)-
methyl triphenylphosphonium bromide (4) with various aldehydes^{a}.

| | | | Reaction | Yield |
|---|---|---|---|---|
| Entry | Aldehyde | Product | time (h) | (%)^{b} |
| 1 | 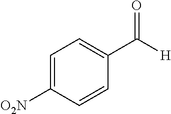 [SMILES: O=Cc1ccc([N+](=O)[O-])cc1] | 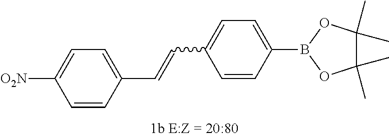 [SMILES: CC1(C)OB(c2ccc(C=Cc3ccc([N+](=O)[O-])cc3)cc2)OC1(C)C] | 2 | 92 |
| 2 | 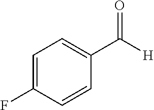 | 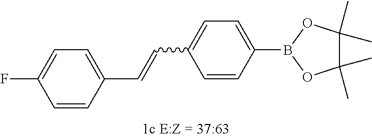 [SMILES: CC1(C)OB(c2ccc(C=Cc3ccc(F)cc3)cc2)OC1(C)C] | 4 | 94 |
| 3 | 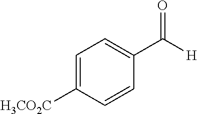 [SMILES: COC(=O)c1ccc(C=O)cc1] | 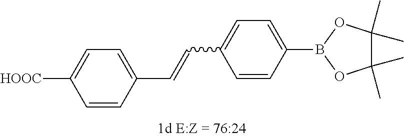 [SMILES: CC1(C)OB(c2ccc(C=Cc3ccc(C(=O)O)cc3)cc2)OC1(C)C] | 12 | 74 |
| 4 | 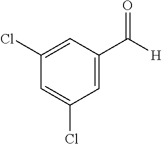 | 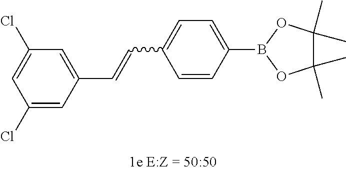 [SMILES: CC1(C)OB(c2ccc(C=Cc3cc(Cl)cc(Cl)c3)cc2)OC1(C)C] | 6 | 72 |
| 5 | 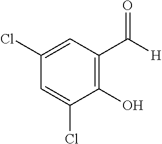 [SMILES: O=Cc1cc(Cl)cc(Cl)c1O] | 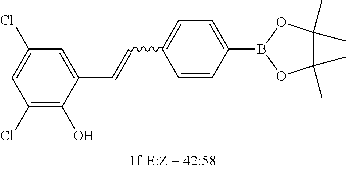 [SMILES: CC1(C)OB(c2ccc(C=Cc3cc(Cl)cc(Cl)c3O)cc2)OC1(C)C] | 12 | 81 |
| 6 | 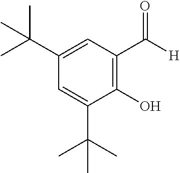 [SMILES: CC(C)(C)c1cc(C=O)c(O)c(C(C)(C)C)c1] | 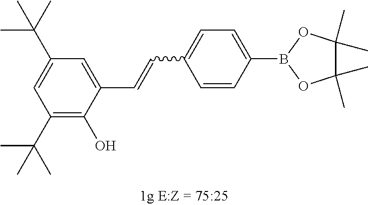 [SMILES: CC(C)(C)c1cc(C=Cc2ccc(B3OC(C)(C)C(C)(C)O3)cc2)c(O)c(C(C)(C)C)c1] | 12 | 71 |
| 7 | 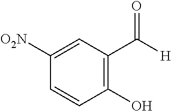 [SMILES: O=Cc1cc([N+](=O)[O-])ccc1O] | 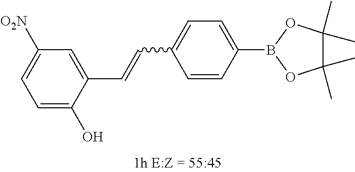 [SMILES: CC1(C)OB(c2ccc(C=Cc3cc([N+](=O)[O-])ccc3O)cc2)OC1(C)C] | 10 | 76 |
| 8 | 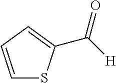 | 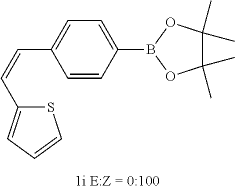 [SMILES: CC1(C)OB(c2ccc(/C=C\c3cccs3)cc2)OC1(C)C] | 2 | 87 |
| 9 | 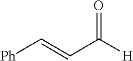 | 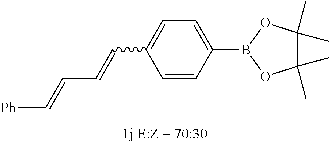 [SMILES: CC1(C)OB(c2ccc(C=C/C=C/c3ccccc3)cc2)OC1(C)C] | 5 | 88 |
| 10 | 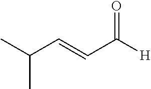 | 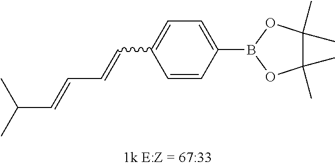 [SMILES: CC(C)/C=C/C=Cc1ccc(B2OC(C)(C)C(C)(C)O2)cc1] | 11 | 85 |

^{a}All reactions were performed using 1 equivalent of aldehyde and 3 equivalents of ^{t}BuONa in DMF for 2-12 h.
^{b}Isolated yield (mixture of E and Z) refers to aldehyde and the E/Z ratios were determined by ¹H NMR.

Having established the preferred, reaction conditions, this methodology was applied to synthesize a boron-containing resveratrol derivative 1o (Scheme 3). Boronate phosphonium ylide 4 readily reacted with 4-hydroxy benzaldehyde in the presence of tBuONa in DMF to yield 58% of compound 1o, EZ isomer ratio 70:30.

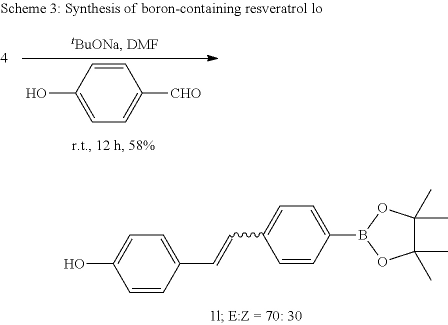 [SMILES: O=Cc1ccc(O)cc1 ; CC1(C)OB(c2ccc(C=Cc3ccc(O)cc3)cc2)OC1(C)C]

Also, a one-pot Wittig reaction was developed. In this case, 4-(4,4,5,5-tetramethyl-1,3,2-dioxaboratophenyl)-methyl triphenylphosphonium bromide (4), the intermediate generated by reaction of 6 with triphenylphosphine, was reacted directly with methyl-4-formyl benzoate in the presence of a base, and the desired boron-containing stilbene carboxylic acid 1d product was isolated in 75% overall yield as a one-pot Wittig reaction followed by acid hydrolysis (Scheme 4).

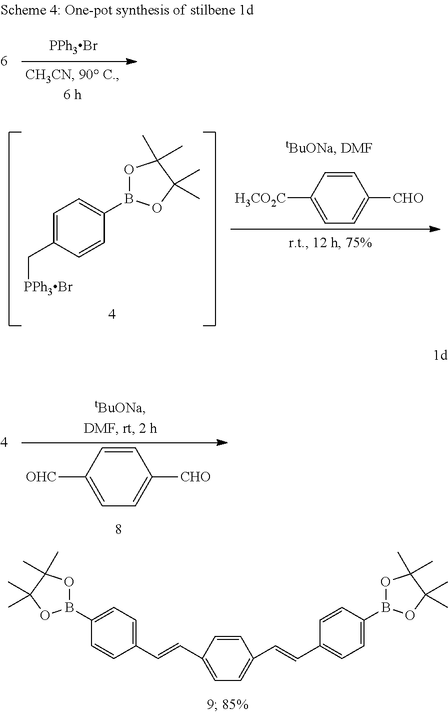

After generalizing the reaction conditions, the Wittig reaction of ylide-4 with benzene-1,4-dicarbaldehyde 8 to synthesize the boron capped polyene system (as useful intermediate to synthesize conjugated polyene (9) was examined and the results are depicted in Scheme 4. The boronate ylide 4 underwent Wittig reaction with benzene-1,4-dicarbaldehyde 8 to provide diboronate of 1,4-distyryl-benzene 9 with good yield (85%).

In conclusion, 4-(4,4,5,5-tetraethyl-1,3,2-dioxaboratophenyl)-methyl triphenyl-phosphonium bromide was successfully prepared using PPh₃ and the corresponding 2-[4/-(bromomethyl)phenyl]-4,4,5,5-tetramethyl-1,3,2-dioxaborolane in acetonitrile under refluxing conditions and this salt was used to develop a novel direct route to synthesize boron-containing stilbene derivatives via the Wittig reaction with various aldehydes, to yield 71-94%. Additionally, a one-pot protocol was developed. This methodology was used t synthesize boron containing resveratrol analogues and boron containing polyene chains.

### Biological Example No. 1

### Antibodies

Anti-Flag M2 was purchased from Sigma (St. Luis, Mo.). Anti-HA was purchased from Covance Research Products. Anti-SIRT1 and anti-acetyl were purchased from Cell Signaling. Anti-beta-tubulin antibodies were obtained from Invitrogen (Life Technologies, Carlsbad, Calif.).

Tissue Culture

HepG2, HEK293 cells, and MEFs were cultured at 37° C. and 5% CO₂ in Dulbecco's modified Eagle's medium (DMEM; Sigma), supplemented with 100 mg/ml of penicillin-streptomycin (GIBCO-BRL), 10% (or otherwise indicated) fetal bovine serum (Hyclone), and 20 mM Glutamine.

Plasmids

Full-length human SIRT1 cDNA (wild-type or H363Y mutated) was subcloned into pcDNA4/TO-Flag or pGEX-2TKN. Human SREBP-1a cDNA encoding amino acids 1-487 was subcloned into pcDNA4/TO with an N-terminal Flag-tag.

Transfection and siRNA

To over-express epitope-tagged proteins in HeLa and 293T cells, 2 ug of plasmid DNA was transfected by Lipofectamine™ 2000 (Invitrogen, Life technologies, Carlsbad, Calif.) into each well (4×105 cells) of six-well plates. Whole cell extracts were prepared after 24 hours of culture. Smart pool of double stranded siRNA oligonucleotides (control or SIRT1) were synthesized by Dharmacon Research, Inc. (Lafayete, Colo.). SiRNA oligos (1 μg/well) were transfected into HeLa cells in six-well plates by Lipofectamine™ 2000. After 48 hours, cells were re-plated into 24-well plates and were transfected with reporter vectors. Cell extracts for immuno-detection of SIRT1 and β-tubulin were generated 65 hour after siRNA transfection.

Immunoprecipitation and Immunoblotting

For immunoprecipitation, 5 μl of anti-Flag were incubated with 20 μl protein A/G beads (Pharmacia) for 1 hour mutating at room temperature. After extensive washes, 1 ml of HeLa or 293T whole cell lysates were incubated for 3 hours mutating at 4° C. with the antibody-coupled protein A/G beads. The beads were washed five times with 1 ml of wash buffer containing 20 mM HEPES at pH 7.6, 250 mM KCl, 0.1 mM EDTA, 10% glycerol, 0.1% NP-40, 1 mM DTT, 1 mM benzamidine, 0.25 mM PMSF, and 2 μg/ml aprotinin. The interacting proteins were then eluted with binding buffer containing 10 mM Flag peptide (for Flag-tagged proteins) for 1 hour at 4° C. For immunoblotting, protein samples were resolved by SDS-PAGE and transferred to PVDF membranes. The membranes were blocked, by 0.5% nonfat milk for 1 hour at room temperature and were incubated with primary antibodies overnight at 4° C. After several washes, the membranes were incubated with HRP-conjugated secondary antibody for 1 hour at room temperature. After several washes, specific protein signals were visualised by addition of chemiluminescent substrates and exposure to X-ray films.

In Vitro Deacetylation Assay

GST-fusion proteins (GST alone, GST-SIRT1wt, and GST-SIRT1H363Y) were expressed in E. coli (BL21) and purified from the lysates by glutathione-sepharose beads (Pharmacia). The amount of GST proteins was estimated using SDS-PAGE followed by Coomassie staining. Flag-tagged SREBP-1a proteins were expressed in HeLa cells and purified by IP. The purified SREBP-1a was incubated with purified GST-fusion proteins at 30° C. for 1 hr either in the presence or absence of 5 mM NAD. The reactions were performed in a buffer containing 50 mM Tris-HCl (pH 9.0), 50 mM NaCl, 4 mM MgCl₂, 1 mM ZnCl₂, 0.5 mM DTT, 0.2 mM PMSF, 0.02% NP-40, and 5% glycerol. The reactions were resolved on SDS-PAGE and analyzed by immunoblotting.

Drosophila Treatment and Culture

All flies were cultured on standard cornmeal-agar-molasses medium and w1118 strain was used as the wild-type control. A sir2 null allele (Sir22A-7-11) deletes the entire coding sequence of the sir2 gene and was generated by targeted knockout (Xie, H. B., and Golic, K. G., Gene deletions by ends-in targeting in Drosophila melanogaster. Genetics 168: 1477-1489, 2004). The homozygous mutant animals of this sir2 null allele are viable, allowing us to collect third instar mutant larvae for Oil Red O staining and qRT-PCR analyses. Early third instar larvae of sir2 mutants w1118; Sir22A-7-11; +) or control (w1118; +; +) were maintained in vials containing either normal food, or 1% agarose gel in PBS for fasting treatment, for 24 hours at 25° C.

Oil Red O Staining of Fat Bodies

The heads of ˜20 larvae of each genotype and treatment were removed using force, their bodies were subsequently everted inside-out to expose the entire fat bodies. These partially dissected larvae were then fixed in 4%, paraformaldehyde in PBS for 15 minutes at room temperature, followed by two rinses with distilled water. 12 ml of 0.1% Oil Red O in isopropanol was first mixed with 4.5 ml of distilled water, then filtered through 0.45 nm filter. 4 ml filtered Oil Red O was then added to each sample of fixed larvae, rocking for 25 minutes at room temperature, then rinsed with distilled water twice. For quantification, Oil Red from 3-4 samples per genotype/treatment; with 5 stained larvae per sample, was extracted with 1.5 ml isopropanol (rocking over night), than measured O.D. at 510 nm.

Quantitative RT-PCR Assay

Total RNA was extracted from cells with Trizol (Invitrogen, Carlsbad, Calif.) and quantified with an Agilent 2100 Bioanalyzer (Agilent Technologies, Santa Clara, Calif.). For mRNA quantification, 2 ug of RNA was converted to cDNA with a High Capacity cDNA Reverse Transcription kit (Applied Biosystems, Foster City, Calif.), and transcript levels of relevant genes were determined by real-time, quantitative PCR with an ABI 7300 Real Time PCR machine according to the manufacturers instructions.

Quantitative measurement of fatty acids and cholesterol synthesis Fatty acids and cholesterol synthesis rate was determined using the deuterated water—GC/MS method as described previously.

Statistical Analysis

Results are represented as the means±S.D. Statistical significance was determined using a paired two-tailed Student's t test, with p<0.05 considered significant.

Results

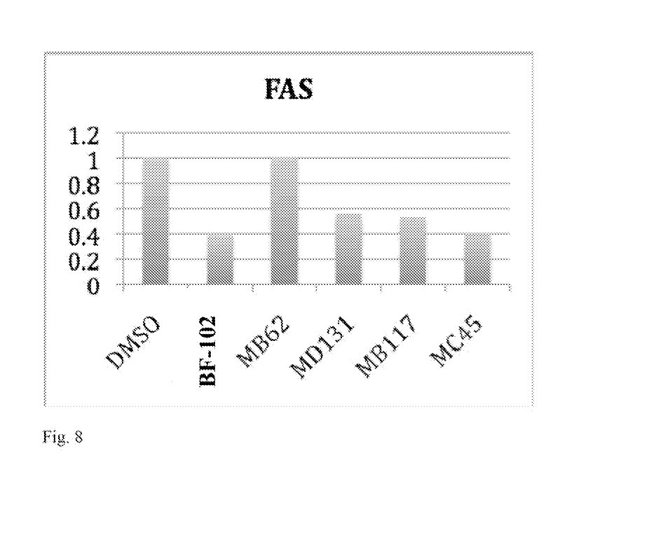

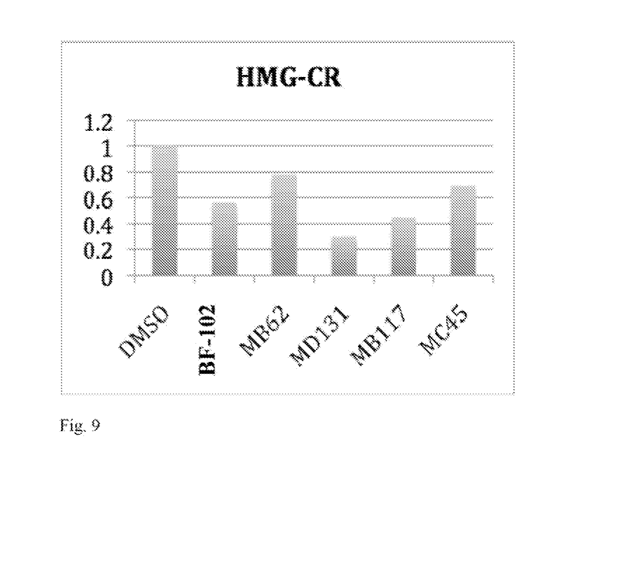

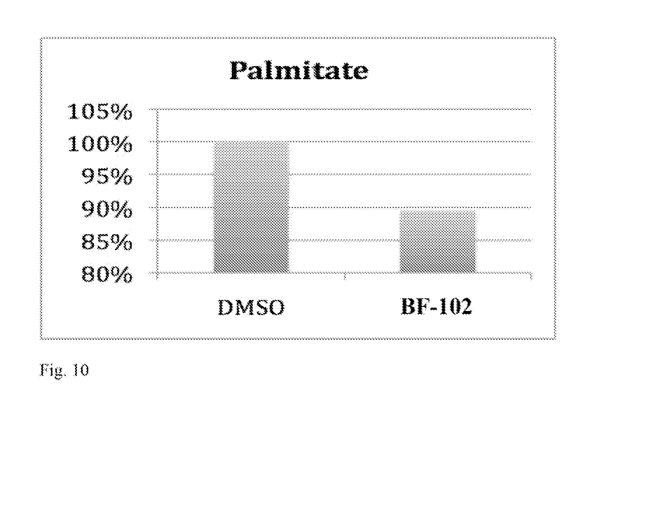

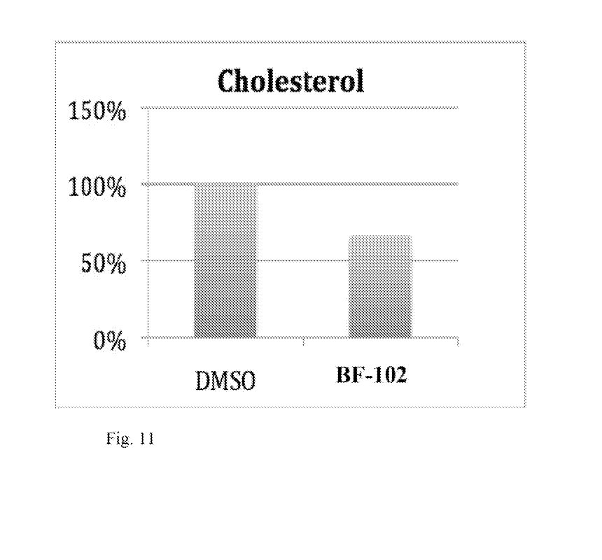

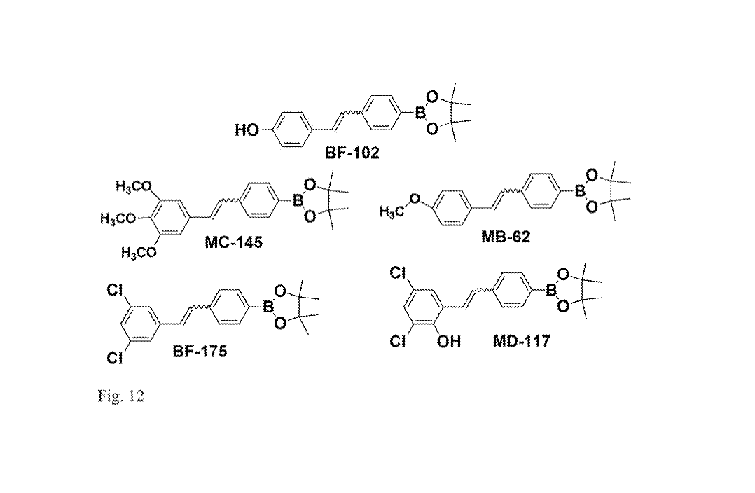

Since the anti-aging gene SIRT1 represses SREBP-dependent functions, it was tested whether the compounds could inhibit SREBP-target gene expression. As shown in FIGS. 8 and 9, treating human hepatoma cells HepG2 with 0.03 mM of compounds BF-102, MD131, MB117 or MC45 (see FIG. 12 for structures) resulted in strong inhibition of fatty acid synthase and HMG-CoA reductase mRNA levels, although compound MB62 was less effective. In HepG2 and 293 cells, 0.1 mM BF-102 has no significant cytotoxicity, while MC45 is toxic to those cells (data not shown). Consistent with the gene expression data FIGS. 10 and 11 show that compound BF-102 inhibits palmitate and cholesterol synthesis in HepG2 cells. Thus, these SIRT1 activators (especially BF-102) have inhibitory effects on both fatty acid and cholesterol synthesis through repressing SREBP transcription factors. The compounds can be used to treat human diseases caused by over-production of fat and cholesterol.

### Biological Example No. 2

### Antibodies

Anti-SREBP-1 antibody was purchased from Santa Cruz Biotechnology, Inc., anti-fatty acid synthase from Cell Signaling Technology, Inc. (Danvers, Mass.), and anti-β-tubulin antibody from Invitrogen (Life Technologies, Carlsbad, Calif.).

Tissue Culture

HepG2 and FAO cells as well as primary rat hepatocytes were cultured at 37° C. and 5% CO₂ in Dulbecco's modified Eagle's medium (DMEM; Sigma, St. Louis, Mo.), supplemented with 100 mg/ml of penicillin-streptomycin (P/S, GIBCO-BRL), 10% fetal bovine serum (FBS, Hyclone) and 20 mM glutamine. Primary rat hepatocytes were isolated using a method as described previously (20), and plated onto collagen-coated 6-cm dishes (3×10⁶ cell/dish) in DMEM containing 10% FBS; 100 mg/mL P/S, 20 mM glutamine, 100 nM insulin and 1 μM dexamethasone. After 4 hours of culture, non-adherent cells were washed away with 1×PBS. The remaining hepatocytes were cultured or treated in regular DMEM medium.

Animals and Animal Care

Male C57BI/6J mice were purchased from The Jackson Laboratory at 8 weeks of age and were rendered insulin resistant by feeding an HFD (60% kcal from fat; D12492, Research Diets) for 4 weeks. Then the treatment with BF-102 or BF175 was performed for 1 week (osmotic pumps) or several weeks (in HFD).

Plasma triglyceride (TG) levels were measured with the TG kit (Sigma, St. Louis, Mo.). Glucose tolerance tests (GTT) were performed on overnight-fasted mice. For GTT, animals were injected intraperitoneally with dextrose (1 g/kg, Hospira, Inc). Blood samples were drawn at 0, 15, 30, 60, and 120 min after dextrose injection and blood glucose was measured using a One-Touch glucose-monitoring system (Lifescan). For physiological analysis, mice were individually placed in metabolic cages and monitored for 24 hours.

Animals were maintained on a 12-h/12-h light/dark cycle with free access to HFD food and water. All animal procedures were in accordance with Albert Einstein College of Medicine research guidelines for the care and use of laboratory animals.

Immunoblotting

Proteins were extracted in a lysis buffer containing 20 mM HEPES at pH 7.6, 150 mM NaCl, 0.1 mM EDTA, 10% glycerol, 0.1% NP-40, 1 mM DTT, 1 mM benzamidine, 0.25 mM PMSF, and 2 μg/ml aprotinin. For immunoblotting, protein samples were resolved by SDS-PAGE and transferred to PVDF membranes. The membranes were blocked by 0.5% nonfat milk for 1 hour at room temperature and were incubated with primary antibodies overnight at 4° C. After 3 washes (10 min each) with 1×TBST buffer, the membranes were incubated with HRP-conjugated secondary antibody for 1 hour at room temperature. After 3 washes (10 min each) with 1×TBST buffer, specific protein signals were visualized by addition of chemiluminescent substrates and exposure to X-ray films.

Quantitative RT-PCR Assay

Total RNA was extracted from cells with Trizol (Invitrogen, Life Technologies, Carlsbad, Calif.) and quantified with an Agilent 2100 Bioanalyzer. For mRNA quantification, 2 μg of RNA was converted to cDNA with a High Capacity cDNA Reverse. Transcription kit (Applied Biosystems, Foster City, Calif.), and transcript levels of relevant genes were determined by real-time, quantitative PCR with an ABI 7300 Real Time PCR machine according to the manufacturer's instructions. (PCR primer information is available upon request)

Quantitative Measurement of Fatty Acids and Cholesterol Synthesis

Fatty acids and cholesterol synthesis rate was, determined using the deuterium enrichment method followed by GC/MS analysis. Briefly, cells were cultured in regular DMEM medium containing 10% 2H₂O for 18 hours. Fatty acids and cholesterol were purified by extraction with organic solvents chloroform/methanol and quantitatively measured by GC/MS. The synthesis rates were presented as the percentage of ²H-containing palmitate or cholesterol in total amount of palmitate or cholesterol.

Drosophila Culture

All flies were cultured on standard cornmeal-agar-molasses medium and w1118 strain was used as the wildtype control. A sir2 null allele (Sir22A-7-11) deletes the entire coding sequence of the sir2 gene and was generated by targeted knockout (21). The homozygous mutant animals of this sir2 null allele are viable, allowing us to collect third instar mutant larvae for Oil Red O staining and qRT-PCR analyses. Early third instar larvae of sir2 mutants (w1118; Sir22A-7-11; +) or control (w1118; +; +) were maintained in vials containing fly food at 25° C.

Oil Red O Staining of Drosophila Fat Bodies

The heads of ˜20 larvae of each genotype and treatment were removed using forceps, their bodies were subsequently inverted inside-out to expose the entire fat bodies. These partially dissected larvae were then fixed in 4% para-formaldehyde in PBS for 15 minutes at room temperature, followed by two rinses with distilled water. 12 ml of 0.1% Oil Red O in isopropanol was first mixed with 4.5 ml of distilled water, then filtered through 0.45 nm filter. 4 ml filtered Oil Red O was then added to each sample of fixed larvae, rocking for 25 minutes at room temperature, then rinsed with distilled water twice. For quantification, Oil Red from 3-4 samples per genotype/treatment, with 5 stained larvae per sample, was extracted with 1.5 ml isopropanol (rocking over night), than measured OD at 510 nm.

In Vitro Analysis of SIRT1 Activity

The effect of BF175 on SIRT1 activity in vitro was analyzed using a kit from Cayman Chemical (Charlotte, N.C.).

Statistical Analyses

Data are presented as the means±S.D. The significance of differences between two groups was evaluated using Student's t test. The p value<0.05 was considered significant.

### Results

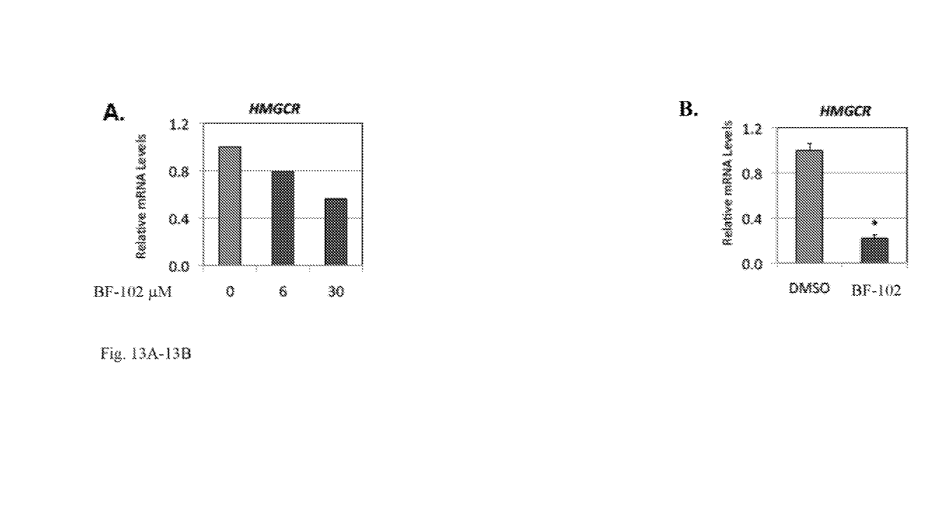

To search for lipogenic inhibitors, a library of limited number of boron-containing novel compounds were screened for their effects on FAS gene expression in human hepatoma cell-line, HepG2. Treatments with some of the compounds, including BF-02, BF175, MD117 and MC145 as shown in FIG. 13A, at 30 μM resulted in a significant decrease of FAS mRNA levels as measured by quantitative RT-PCR (qRT-PCR) (8), although some compounds, such as MB62, were inactive in this assay (FIG. 8). Two compounds, BF-102 and BF175, were chosen for further analysis because they appeared to be not toxic to HepG2 cells at the doses used (data not shown).

Since FAS is a rate-limiting enzyme in de novo lipogenesis, it was decided to determine whether inhibition of FAS gene expression by BF-102 could result in a decrease of fatty acid synthesis. Consistent with gene expression data, using the deuterium enrichment method followed by gas chromatography mass spectrometry (GC/MS), it was found that 20 μM of BF-102 can significantly decrease the synthesis rate of palmitate, the product of FAS, in rat hepatocytes, FAO cells in the presence of 100 nM insulin (FIG. 10). Thus, BF-102 can inhibit de novo lipogenesis.

Next, whether BF-102 also affected the cholesterol biosynthesis pathway was tested. Using qRT-PCR, it was found that BF-102 treatment can dose-dependently decrease the mRNA levels of HMGCR, a rate-limiting enzyme for cholesterol biosynthesis and the target of well-known cholesterol lowering drug statins, in HepG2 cells (FIG. 13A). Using the deuterium enrichment method followed by GC/MS, it was found that 20 μM of BF-102 can dramatically decrease the synthesis rate of cholesterol in FAO cells in the presence of 100 nM insulin (FIG. 11). In view of the encouraging BF-102 data in cultured cells, its effects in vivo were tested. Initially, no apparent toxic responses were observed in male C57BL/6J mice under standard chow after one week of administrating BF-102 (total of 0.6 mg/g body weight) by osmotic pumps. Then, BF-102 was tested in the well-established mouse model of diet-induced obesity. Eight-week old C56BL/6J mice were fed with high-fat diet (HFD) containing 60% fat for 4 weeks to establish a disease state and treated for 1 week of BF-102 (0.3 mg/g body weight) by osmotic pumps. All mice were continuously fed with HFD during the treatment. As shown in FIG. 13B, the hepatic mRNA levels of HMGCR were dramatically reduced by ˜5 fold when compared with the controls that were treated with DMSO, the solvent that was used to dissolve BF-102. In addition, other lipogenic genes, such as FAS, were also significantly down regulated (data not shown). Together, the data strongly suggest that BF-102 inhibits both lipogenesis and cholesterogenesis by down-regulating SREBP-target genes.

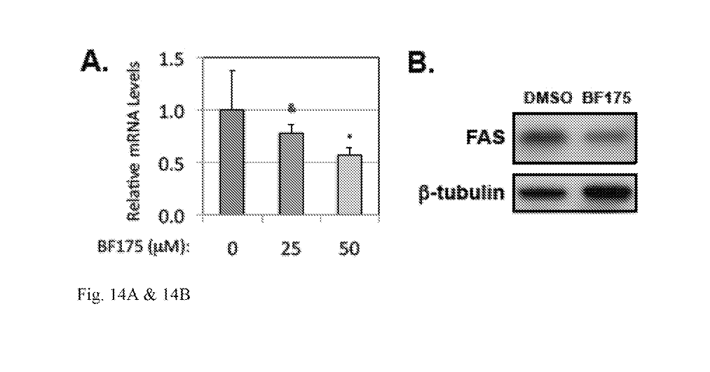

Using qRT-PCR, it was found that another boron-containing compound, BF175, which is more soluble than BF-102, also can dose-dependently decrease the mRNA levels of FAS and other SREBP target genes in HepG2 cells (FIG. 14A and data not shown). Furthermore, BF175 treatment in isolated primary rat hepatocytes can significantly reduce the protein levels of FAS as detected by Western blots (FIG. 14B). Thus, BF175 is a potent inhibitor of lipogenic gene expression in cultured cells.

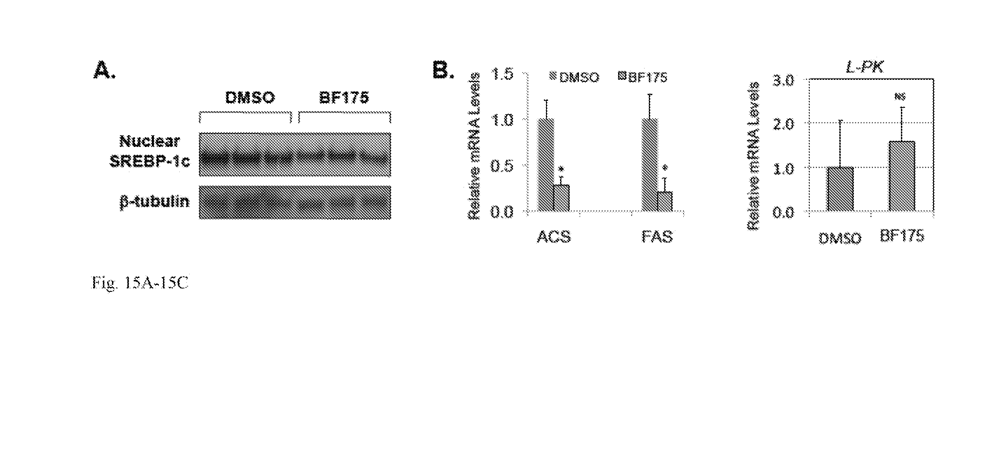

The potent inhibitory effects of BF175 on lipogenic gene expression in cultured hepatocytes prompted us to test whether BF175 had any effects in treating diet-induced obesity. Similar to the experiments with BF-102, BF175 was initially tested for a week (0.3 mg/g body weight) by osmotic pumps and HFD in mice that were already fed with HFD for 4 weeks. As shown in FIG. 15A, BF175 treatment significantly reduced the protein levels of nuclear/active form of SREBP-1c and total FAS in mouse livers (data not shown). Consistent with the lower SREBP-1c protein levels, BF175 treatment dramatically decreased the hepatic mRNA levels of SREBP-target genes, such as acetyl-CoA synthetase (ACS), FAS and HMGCR (FIG. 15B and data not shown). The in vivo effects of BF175 are likely through SREBPs, because it did not show significant effects on the mRNA levels of live-specific pyruvate kinase (L-PK), a known target of carbohydrate regulatory element binding protein (ChREBP) (19), but not a target of SREBPs (20).

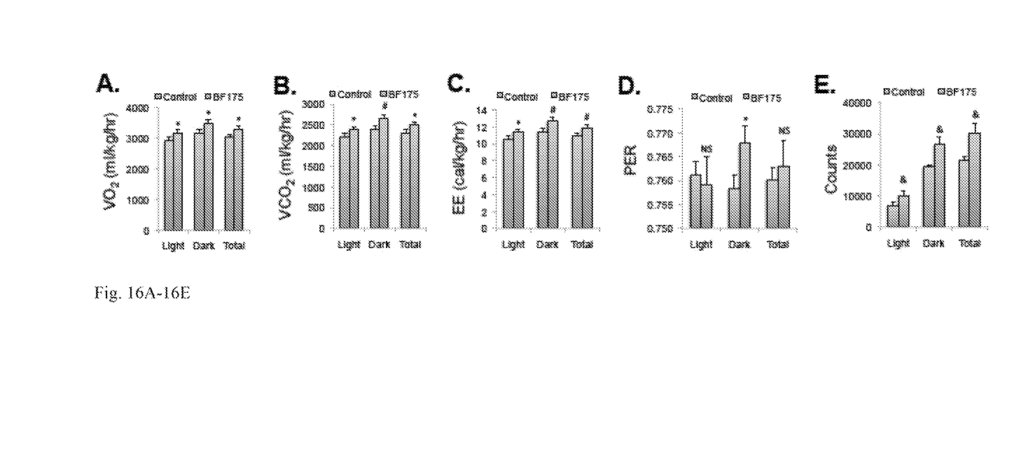

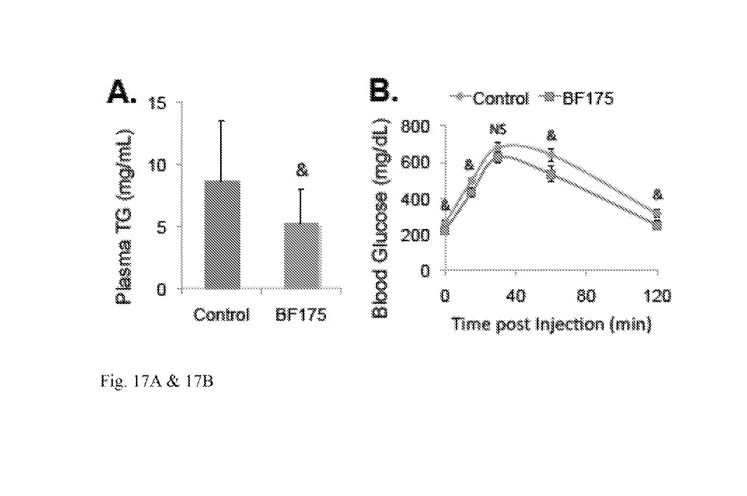

The in vivo effects of BF175 on SREBP-target gene expression in HFD-induced obesity model led to determining whether this compound had any physiologic benefits to those mice. For that purpose, the treatment of BF175 was repeated with the osmotic pump approach and on mice housed individually in metabolic cages for the last 24 hours of treatment. As shown in FIG. 17, significant changes in several readouts were observed. BF175 treatment increased oxygen consumption (FIG. 16A) and CO₂ production (FIG. 16B) during both the light and dark periods, consistent with the increase of energy expenditure (FIG. 16C). In addition, BF175 treatment slightly increased the use of carbohydrates vs. fat during the dark feeding period (FIG. 16D), while there was no significant change in overall preference of energy sources. Interestingly, BF175 treatment significantly increased the overall activity in HFD-fed mice (FIG. 16E), suggesting that BF175 improves health in those animals. In addition, consistent with the hepatic gene expression data, a significant decrease of plasma triglycerides was detected after one week of BF175 treatment using osmotic pumps in HFD-induced obese models (FIG. 17A). Together, the data suggest beneficial effects of short-term treatment with BF175 in HFD-induced obese models.

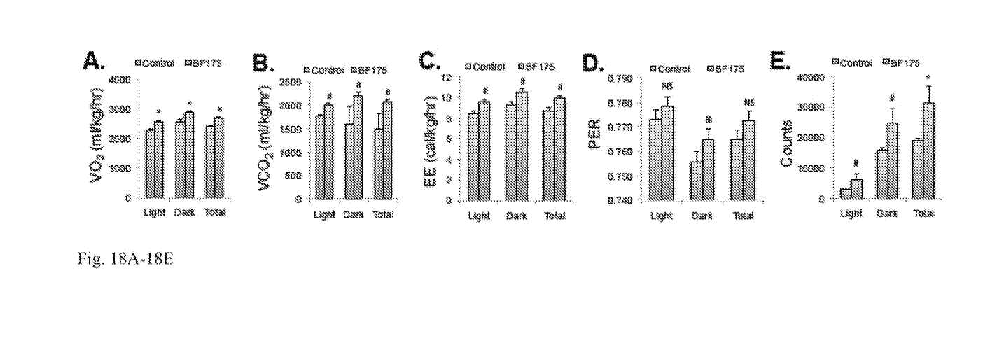

To avoid the limitation of osmotic pumps, it was decided to determine whether oral administration of BF175 had any beneficial effects in the mouse model of HFD-induced obesity. Again, eight-week old C57BL/6J mice were fed with HFD for four weeks to establish the disease models. Then, mice were treated with BF175 that was mixed in HFD. After four weeks of treatment, glucose tolerance tests were performed and BF175-treated had slightly improved, but significant, glucose tolerance when compared with the controls (FIG. 17B). After five weeks of treatment, those mice were placed individually in metabolic cages. Similar to the data observed from using osmotic pumps, dietary BF175 treatment increased oxygen consumption (FIG. 18A) and CO₂ production (FIG. 18B) during both the light and dark periods, consistent with the increase of energy expenditure (FIG. 18C). In addition, BF175 treatment also slightly increased the use of carbohydrates verse fat during the dark feeding period (FIG. 18D), and significantly increased the overall activity in HFD-fed mice (FIG. 18E). Furthermore, dietary treatment with BF175 significantly decreased the rate of body weight gain, while there was no difference in food intake (data not shown). Together, the data suggest beneficial effects of oral treatment with BF175 in HFD-induced obese models.

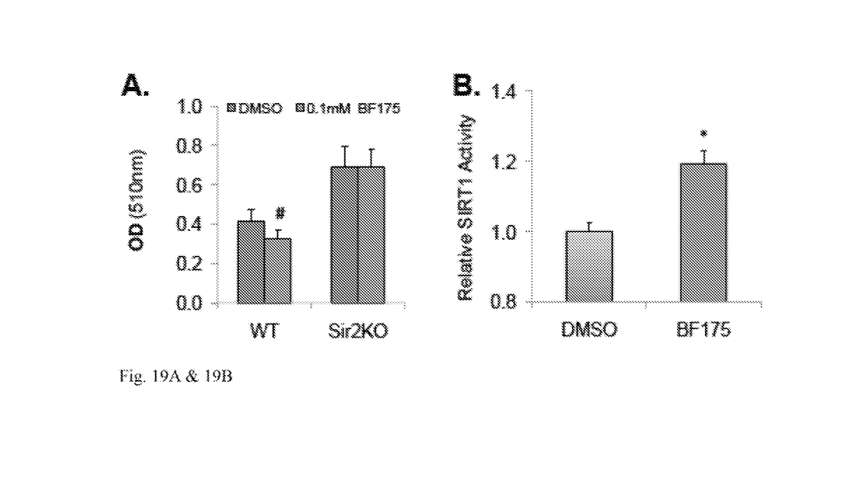

Studies have demonstrated a critical and conserved role of Sir2/SIRT1 in the repressing SREBP-dependent functions in multiple organisms, including Drosophila (14-16). To examine whether these boron-containing compounds also inhibit lipid accumulation in flies, Drosophila larvae were fed with fly food containing BF175or BF-102. The amount of lipids in Drosophila larvae was quantified after staining with Oil Red O. As shown in FIG. 20A, treatment with BF175 caused a significant loss of ˜20% of fat in Drosophila larvae. BF-102 had similar effects (data not shown). Importantly, this effect was observed in wild-type Drosophila larvae. In Sir2 knockout Drosophila larvae, no difference in twelve independent experiments was observed (FIG. 19A). Thus, it is concluded that the inhibitory effect of these compounds on SREBP-target gene expression and lipogenesis requires Sir2/SIRT1 in vivo. In fact, in vitro assays have shown that BF175 can weakly increase the activity of SIRT1 (FIG. 19B), suggesting that BF175 functions through activating Sir2/SIRT1 to repress SREBP and lipogenesis in vivo.

In addition, compounds disclosed herein had an inhibitory effect on proliferation of cancer cell lines (data not shown).

In summary, herein is disclosed the synthesis of BF-102 and BF175 which are novel, bio-active boron-containing compounds which inhibit SREBP-target gene expression and biosynthesis of fatty acid and cholesterol in cultured hepatocytes and in vivo. In addition, BF175 has beneficial effects in treating HFD-induced obesity in animal model. The lipid-lowering function of these compounds requires Sir2/SIRT1. In addition, it is expected that the compounds can be used to treat cancer and/or reduce or reverse the effects of aging.

### REFERENCES

1. Eberle, D., Hegarty, B., Bossard, P., Ferre, P., and Foufelle, F., SREBP transcription factors: master regulators of lipid homeostasis, Biochimie, 86, 839 (2004).
2. Haigis, M. C., and Guarente, L. P., Mammalian sirtuins—emerging roles in physiology, aging, and calorie restriction, Genes and Development, 20, 2913 (2006).
3. Michan, S., and Sinclair, D., Sirtuins in mammals: insights into their biological function, Biochemical Journal, 404, 1 (2007).
4. Athar, M.; Ho Back, J.; Tang, X.; Ho Kim, K.; Kopelovich, L.; Bickers, D. R.; Kim, A. L. Toxicol. Appl. Pharmacol. 2007, 224, 274.
5. Wittig: (a) Lautens, M.; Mancuso, J. J. Org. Chem. 2004, 69, 3478. (b) Lautens, M.; Marquardt, T. J. Org. Chem. 2004, 69, 4607. (c) Kobayashi, Y. et al. Tetrahedron Lett. 1998, 39, 7537. (d) Kobayashi, Y.; Tokoro, Y.; Watatani, K. Eur. J. Org. Chem. 2000, 3825.
6. Horner-Wittig-Emmons: (a) Schmidt, U.; Leitenberger, V.; Griesser, H.; Schmidt, J.; Meyer, R. Synthesis 1992, 1248. (b) Park, k. c.; Yoshino, k.; Tomiyasu, H. Synthesis 1999, 2041. (c) Busnel, O.; Carreaux, F.; Carboni, B.; Pethe, S.; Goff, S. V.-L.; Mansuy, D.; Boucher, J.-L. Bioorg. Med. Chem. 2005, 13, 2373. (d) Gopalarathnam, A.; Nelson, S. G. Org. Lett. 2006, 8, 7.
7. Molander, G. A.; Ham, J.; Canturk, B. Org. Lett. 2007, 9, 821.
8. Zhang, C., Zhemg, G.; Fang, L.; Li, Y. Synlett. 2006, 3, 475.
9. Iwadate, N.; Suginome, M. Org. Lett., 2009, 11, 1899.
10. Osborne, T. F., and Espenshade, P. J. (2009) Genes Dev 23, 2578-2591
12. Eberle, D., Hegarty, B., Bossard, P., Ferre, P., and Foufelle, F. (2004) Biochimie 86, 839-848
13. Sato, R. (2009) FEBS J 276, 622-627
14. You, M., Liang, X., Ajmo, J. M., and Ness, G. C. (2008) Am J Physiol Gastrointest Liver Physiol 294, G892-898
15. Walker, A. K., et al., Genes Dev 24, 1403-1417 (2010)
16. Ponugoti, B., et al. J Biol Chem 285, 33959-33970 (2010)
17. Haigis, M. C., and Sinclair, D. A. Annu Rev Pathol 5, 253-295 (2010)
18. Michan, S., and Sinclair, D. (2007) Biochem J 404, 1-13
19. Ishii, S. et al. (2004) Proc Natl Acad Sci USA 101, 15597-15602
20. Stoeckman, A. K., and Towle, H. C. (2002) J Biol Chem 277, 27029-27035
21. Xie, H. B., and Golic, K. G. (2004) Genetics 168, 1477-1489

1. A compound having the structure: 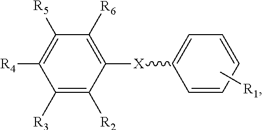
wherein R₁ is 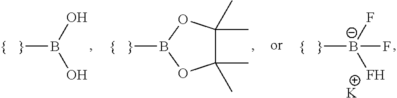
wherein the { } represents the point of attachment of R₁ to the right hand aryl ring;
wherein X is either: 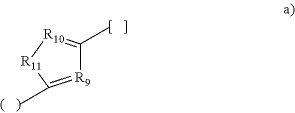
wherein (i) R₉ is C and R₁₀ is N and R₁₁ is O or (ii) R₉ and R₁₀ are N and R₁₁ is O; 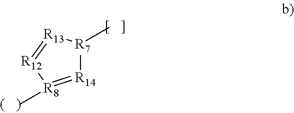
wherein R₈ is C, and wherein (i) R₇, R₁₂ and R₁₃ are N and R₁₄ is C or (ii) R₇, R₁₂, R₁₃ and R₁₄ are N; 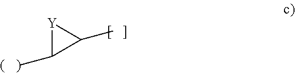
wherein Y is O, C, S or NH; 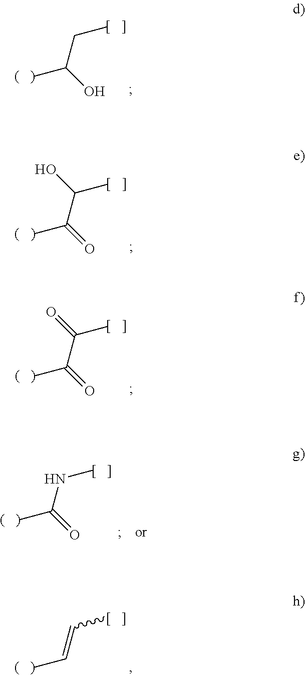
and wherein, in a) through h), ( ) represents the point of attachment to the left hand aryl ring and [ ] represents the point of attachment to the right hand aryl ring;
wherein R₂, R₃, R₄, R₅, and R₆ are, independently, —H, —OH, halogen, —OCH₃, —O—C₂H₂—N(H)(Boc), —O—C₂H₂—NH₂, —O—C₂H₂NHC(═O)CH₂OCH₂OCH₂OC₂H₄OC₂H₄NH₂, C1-C6 alkyl, aryl, phenyl, heteroaryl, arylalkyl, heterocyclic, C2-C6 alkenyl, C2-C6 alkynyl, —NO₂, —OC₂H₅, —O-alkyl, —SH, —S-alkyl, —NH₂, or —NH-alkyl;
or pharmaceutically acceptable salt thereof or a stereoisomer thereof.

2. The compound of claim 1, or pharmaceutically acceptable salt thereof or stereoisomer thereof, wherein when R₄ is —OCH₃, then R₃ and R₅ are —OCH₃.

3. The compound, or pharmaceutically acceptable salt thereof or stereoisomer thereof, of claim 1 having the structure:

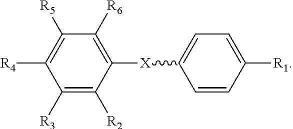

4. The compound of claim 1, or pharmaceutically acceptable salt thereof or stereoisomer thereof, wherein R₂, R₃, R₄, R₅, and R₆ are, independently, —H, —OH, halogen, —OCH₃, —O—C₂H₂—N(H)(Boc), —O—C₂H₂—NH₂, or —O—C₂H₂NHC(═O)CH₂OCH₂OCH₂OC₂H₄OC₂H₄NH₂.

5. The compound of claim 1, or pharmaceutically acceptable salt thereof or stereoisomer thereof, wherein R₄ is —OH and R₂, R₃, R₅ and R₆ are —H; or wherein R₂ is —OH and R₃, R₄, R₅ and R₆ are —H; or wherein R₃ and R₅ are halogen and R₄ is —H, and R₂ and R₆ are, independently, —H or —OH; or wherein R₃, R₄, R₅ are —OCH₃ and R₂ and R₆ are —H,

6. The compound of claim 5, or pharmaceutically acceptable salt thereof or stereoisomer thereof, wherein R₄ is —OH and R₂, R₃, R₅ and R₆ are —H.

7. The compound of claim 6, or pharmaceutically acceptable salt thereof or stereoisomer thereof, wherein R₃ and R₅ are —Cl and R₂, R₄, and R₆ are —H.

8. The compound of claim 7, or
pharmaceutically acceptable salt thereof or stereoisomer thereof, wherein X is

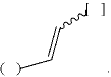

9. The compound of claim 1, or pharmaceutically acceptable salt thereof or stereoisomer thereof, wherein X is

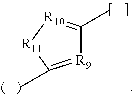

10. The compound of claim 1, or pharmaceutically acceptable salt thereof or stereoisomer thereof, wherein X is

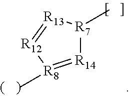

11. The compound of claim 1, or pharmaceutically acceptable salt thereof or stereoisomer thereof, wherein X is

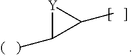

12. The compound of claim 1, or pharmaceutically acceptable salt thereof or stereoisomer thereof, wherein X

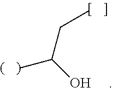

13. The compound of claim 1, or pharmaceutically acceptable salt thereof or stereoisomer thereof, wherein X is

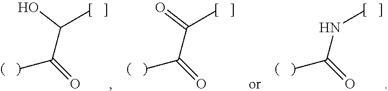

14. The compound of claim 1, or pharmaceutically acceptable salt thereof or stereoisomer thereof, wherein R₁ is:

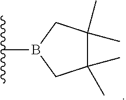 [SMILES: *B1CC(C)(C)C(C)(C)C1]

15. The compound of claim 1, or pharmaceutically acceptable salt thereof or stereoisomer thereof, wherein R₁ is:

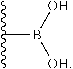 [SMILES: *B(O)O]

16. The compound of claim 1, or pharmaceutically acceptable salt thereof or stereoisomer thereof, wherein R₁ is:

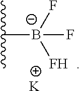 [SMILES: *[B-](F)(F)F ; [K+]]

17.-21. (canceled)

22. A compound having the structure: 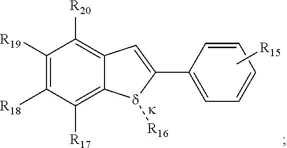
wherein R₁₅ is: 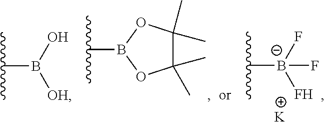
wherein the wavy line represents the point of attachment of R₁₅ to the aryl ring;
wherein atom δ is C, O, N, or S,
and when atom δ is O or S, bond κ and R₁₆ are absent; when atom δ is N, bond κ is present and R₁₆ is H, alkyl or aryl; when atom δ is C, bond κ is present and R₁₆ is H, alkyl or aryl;
where R₁₇, R₁₈, R₁₉ and R₂₀ are, independently, —H, —OH, halogen, —OCH₃, —O—C₂H₂—NH₂, C1-C6 alkyl, aryl, phenyl, heteroaryl, arylalkyl, heterocyclic, alkenyl, C2-C6 alkenyl, C2-C6 alkynyl, —NO₂, —OC₂H₅, —O-alkyl, —SH, —S-alkyl, —NH₂, or —NH-alkyl;
or pharmaceutically acceptable salt thereof or a stereoisomer thereof.

23.-34. (canceled)

35. A composition, comprising the compound, pharmaceutically acceptable salt or stereoisomer, of claim 1.

36. (canceled)

37. The composition of claim 35, wherein the compound has the structure:

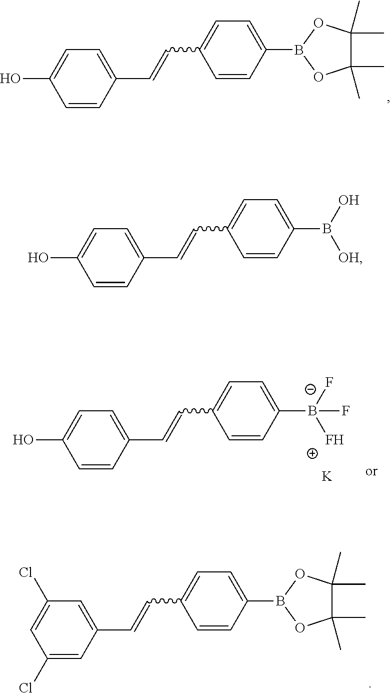

38. (canceled)

39. A method of treating a dyslipidemia in a subject comprising administering to the subject the compound, or pharmaceutically acceptable salt thereof or stereoisomer thereof, of claim 1 in an amount effective to treat the dyslipidemia in the subject.

40.-55. (canceled)
